(19) United States
(12) Patent Application Publication
(10) Pub. No.: US 2026/0178674 A1
(43) Pub. Date: Jun. 25, 2026

(54) GRAPH-BASED INTERPOLATION OF HETEROGENEOUS SENSOR METRICS FOR PRESENTATION AT INCREASED GRANULARITY

(71) Applicants: University of Southern California, Los Angeles, CA (US); California Institute of Technology, Pasadena, CA (US)

(72) Inventors: Johanna Garcia Cardona, La Cañada Flintridge, CA (US); Antonio Ortega, Los Angeles, CA (US); Nereida Rodriguez Alvarez, La Crescenta, CA (US)

(73) Assignee: California Institute of Technology, Pasadena, CA (US)

(21) Appl. No.: 19/105,269

(22) PCT Filed: Aug. 21, 2023
(86) PCT No.: PCT/US2023/030736

§ 371 Date: Feb. 20, 2025

Related U.S. Application Data
(60) Provisional application No. 63/399,837, filed on Aug. 22, 2022.

(51) Int. Cl. G06F 16/9535; G06F 11/34; G06F 16/29; G06F 16/9537

(52) U.S. Cl. CPC G06F 16/9535; G06F 11/3409; G06F 16/29; G06F 16/9537

(57) ABSTRACT

Aspects of this technical solution can generate a first model of a geographic region and including one or more first node metrics at a first granularity, each first node metric indicative of a first physical property at a first location, generate a second model corresponding to the geographic region, the second model including one or more second node metrics at a second granularity greater than the first granularity, each second node metric indicative of a second physical property at a second location, modify the second model to include one or more connection metrics at the second granularity, each connection metric indicative of the second physical property between corresponding second node metrics, and cause, based on the connection metrics, a user interface to present a view of the geographic region including one or more subregions at the second granularity, including quantitative indications of the first physical property at each subregion.

### CROSS-REFERENCE TO RELATED PATENT APPLICATIONS

This application claims the benefit of priority under 35 U.S.C. § 119 to U.S. Provisional Patent Application Ser. No. U.S. 63/399,837, entitled “GRAPH-BASED INTERPOLATION FOR REMOTE SENSING DATA,” filed Aug. 22, 2022, the contents of all such applications being hereby incorporated by reference in its their entirety and for all purposes as if completely and fully set forth herein.

### STATEMENT REGARDING FEDERALLY SPONSORED RESEARCH OR DEVELOPMENT

This invention was made with government support under Grant No. 80NMO0018D0004 awarded by the National Aeronautics and Space Administration (NASA), Jet Propulsion Laboratory (JPL). The government has certain rights in the invention.

### TECHNICAL FIELD

The present implementations relate generally to graph-based interpolation of remote sensor data, including interpolation of satellite sensor data, and in particular, graph-based interpolation to enhance remote sensing data.

### INTRODUCTION

Advances in satellite sensing technology are leading to the deployment of a variety of instruments that observe land surface parameters. These Earth-observing satellites provide information at various spatial and temporal resolutions. For instance, passive sensors including, but not limited to, microwave radiometers provide data at coarse resolutions. Coarse resolutions, however, may provide insufficient information for specific geographical regions and may fail to meet to meet specified minimum criteria for geographical observations. Existing signal processing and geostatistics can partially improve the resolution of coarse data collected satellite sensors. Conventional techniques, however, cannot efficiently or effectively combine observe land surface at sufficient granularity with sufficient responsiveness.

### SUMMARY

This technical solution is directed at least to graph-based interpolation of remote sensor data, including interpolation of satellite sensor data, and in particular, graph-based interpolation to enhance remote sensing data. Thus, a technical solution for graph-based interpolation of heterogeneous sensor metrics for presentation at increased granularity is provided.

At least one aspect is directed to a system. The system can include a memory and one or more processors. The system can generate a first model corresponding to a geographic region, the first model can include one or more first node metrics at a first granularity in the geographic region, each of the first node metrics respectively indicative of a first physical property at a first location of the geographic region. The system can generate a second model corresponding to the geographic region, the second model can include one or more second node metrics at a second granularity in the geographic region greater than the first granularity in the geographic region, each of the second node metrics respectively indicative of a second physical property at a second location of the geographic region. The system can modify the second model to include one or more connection metrics at the second granularity, each of the connection metrics respectively indicative of the second physical property between corresponding ones of the second node metrics. The system can cause, based on the connection metrics, a user interface to present a view of the geographic region can include one or more subregions at the second granularity, each of the subregions can include corresponding quantitative indications of the first physical property at the second location.

At least one aspect is directed to a method. The method can include generating a first model corresponding to a geographic region, the first model can include one or more first node metrics at a first granularity in the geographic region, each of the first node metrics respectively indicative of a first physical property at a first location of the geographic region. The method can include generating a second model corresponding to the geographic region, the second model can include one or more second node metrics at a second granularity in the geographic region greater than the first granularity in the geographic region, each of the second node metrics respectively indicative of a second physical property at a second location of the geographic region. The method can include modify the second model to include one or more connection metrics at the second granularity, each of the connection metrics respectively indicative of the second physical property between corresponding ones of the second node metrics. The method can include causing, based on the connection metrics, a user interface to present a view of the geographic region can include one or more subregions at the second granularity, each of the subregions can include corresponding quantitative indications of the first physical property at the second location.

At least one aspect is directed to a computer readable medium can include one or more instructions stored thereon and executable by a processor. The processor can generate a first model corresponding to a geographic region, the first model can include one or more first node metrics at a first granularity in the geographic region, each of the first node metrics respectively indicative of a first physical property at a first location of the geographic region. The processor can generate a second model corresponding to the geographic region, the second model can include one or more second node metrics at a second granularity in the geographic region greater than the first granularity in the geographic region, each of the second node metrics respectively indicative of a second physical property at a second location of the geographic region. The processor can modify the second model to include one or more connection metrics at the second granularity, each of the connection metrics respectively indicative of the second physical property between corresponding ones of the second node metrics. The processor can cause, based on the connection metrics, a user interface to present a view of the geographic region can include one or more subregions at the second granularity, each of the subregions can include corresponding quantitative indications of the first physical property at the second location.

### BRIEF DESCRIPTION OF THE FIGURES

These and other aspects and features of the present implementations are depicted by way of example in the figures discussed herein. Present implementations can be directed to, but are not limited to, examples depicted in the figures discussed herein. Thus, this disclosure is not limited to any figure or portion thereof depicted or referenced herein, or any aspect described herein with respect to any figures depicted or referenced herein.

FIG. 1 depicts an example system according to this disclosure.

FIG. 2 depicts an example image enhancement system architecture according to this disclosure.

FIG. 3 depicts an example graph enhancement network architecture according to this disclosure.

FIG. 4 depicts an example coarse graph network architecture according to this disclosure.

FIG. 5A depicts an example fine graph network architecture according to this disclosure.

FIG. 5B depicts an example enhanced fine graph network architecture according to this disclosure.

FIG. 6A depicts an example user interface with coarse subregions according to this disclosure.

FIG. 6B depicts an example user interface with enhanced subregions according to this disclosure.

FIG. 7 depicts an example method of generating a plurality of models corresponding to a geographic region.

FIG. 8 depicts an example method of presenting one or more quantitative indications for a geographic region to a user according to this disclosure.

FIG. 9 depicts an example method of presenting one or more quantitative indications for a geographic region to a user according to this disclosure.

FIG. 10A is a diagram illustrating an example computing device according to this disclosure.

FIG. 10B is a diagram illustrating an example computing device according to this disclosure.

### DETAILED DESCRIPTION

Aspects of this technical solution are described herein with reference to the figures, which are illustrative examples of this technical solution. The figures and examples below are not meant to limit the scope of this technical solution to the present implementations or to a single implementation, and other implementations in accordance with present implementations are possible, for example, by way of interchange of some or all of the described or illustrated elements. Where certain elements of the present implementations can be partially or fully implemented using known components, only those portions of such known components that are necessary for an understanding of the present implementations are described, and detailed descriptions of other portions of such known components are omitted to not obscure the present implementations. Terms in the specification and claims are to be ascribed no uncommon or special meaning unless explicitly set forth herein. Further, this technical solution and the present implementations encompass present and future known equivalents to the known components referred to herein by way of description, illustration, or example.

Integrating multiple data sources to improve satellite imagery's temporal and spatial resolution could benefit several environmental monitoring applications. One or more of the examples disclosed herein can incorporate one or more existing signal processing techniques that can be adapted, as described below, to combine multiple remotely sensed datasets to generate one or more remote sensor images at a second granularity (e.g., with a spatially fine resolution). In some examples, the one or more remote sensor images can represent one or more estimates of the remote sensor values, which may be generated according to one or more physical properties at the region associated with the remote sensor values. For example, a remote sensed variable like soil moisture may be spatially smooth in some geographic regions and highly variable in other geographic regions, including geographic regions with a significant variation in one or more of a land use, soil type, or terrain elevation. The examples disclosed herein can use one or more ancillary data (e.g., supplemental variables) including, but not limited to, terrain elevation and vegetation information to generate (e.g., interpolate) a remote sensor image at a second resolution (e.g., enhanced granularity). The present disclosure describes novel systems and methods to use graph-based signal processing to generate enhanced satellite imagery (e.g., interpolate one or more remote sensor datasets), which can include integrating one or more sets of sensor data according to ancillary data (e.g., terrain data). The examples of the present disclosure can incorporate geophysical information within the graph-based interpolation described herein.

The proliferation of Earth-observing satellites has greatly increased the volume and diversity of imagery data, which can be used in one or more examples, including remote sensing. In some examples, one or more earth-observing satellites can be configured to capture detailed imagery of one or more geographic regions at a corresponding granularity (e.g., with a specific temporal, spatial, and/or spectral frequency resolution). For example, the present disclosure can include integrating a plurality of different remote sensor datasets, each of which may be collected by one or more different remote sensors, to generate enhanced sensor datasets at a second granularity. One or more of the examples disclosed herein can generate an enhanced remote sensing dataset and for use in improving the accuracy of various environmental analyses. The enhanced remote sensing data can be used to improve analyses including, but not limited to, environmental conservation analyses, urban planning analyses, agriculture analyses, and/or disaster management analyses.

Different datasets for remote sensing images may not be readily fused (e.g., integrated) due to one or more differences between each dataset. For example, one or more remote sensing datasets can include a first spatial resolution and one or more other remote sensing datasets can have a second spatial resolution, greater than the first resolution, which can be determined by the unique configuration of the remote sensors used to collect each dataset. Additionally, existing techniques to upsample one sensor image to match the resolution of another sensor image can produce inaccurate data, including by creating one or more undesired image artifacts (e.g., generating inaccurate sensor data). Further, enhancing the resolution of a remote sensor image by resampling or existing interpolation techniques can inadvertently induce errors into the resulting remote sensor dataset. Moreover, inferred images can be validated using one or more local observations (e.g., one or more local metrics with a predetermined accuracy and collected by a plurality of in-situ sensors) but that can include corresponding maintenance costs of the in-situ sensors. Ground-based measurements, provided by one or more sensors, can also help improve the temporal resolution of images covering a large geographic area. Accordingly, in some examples, in-situ sensor data can be collected in one or more global, national, or regional networks of one or more in-situ sensors. Even with one or more networks of local sensors, in-situ sensors can be inefficient, or unable, to collect sensor data at a uniform granularity over a large geographic region.

One or more examples described herein can include enhancing the resolution of a satellite-based sensor dataset, which can be according to an underlying observed physical phenomena corresponding to a physical property. Specifically, one or more local smoothness assumptions used in interpolation can be enhanced by using both spatial proximity and information about auxiliary variables (elevation, soil type, land use, etc.), which can influence changes in the measured quantity (e.g., a first physical property) for a geographic region. Therefore, this technical solution provides at least a technical improvement using the data fusion techniques described herein, to integrate information from a variety of different sensors. Additionally, one or more of the techniques described herein can, generate satellite imagery data with an enhanced resolution while preserving the fidelity (e.g., accuracy) of the underlying physical properties.

Techniques for merging remotely sensed images can include one or more statistical-based techniques, image processing methods, and novel machine learning (ML) strategies. Statistical methods can excel in tracking features that evolve gradually over time. However, they may introduce errors when dealing with rapidly changing spatial features. The inability of statistical methods to reconstruct irregular variability often leads to a significant flattening of spatial changes and, consequently, inaccurate representations of retrieved environmental parameters. Also, techniques including, but not limited to, multiple linear and non-linear regression rely heavily on assumptions of linear or non-linear relationships between input and target data. And existing image processing methods do not allow for the inclusion of terrain information, including the high-pass filter (HPF) fusion and the wavelet transform (WVL) fusion. One or more existing machine learning methods, including, but not limited to, random forest regression algorithms and/or Convolutional Neural Networks (CNNs), require a large volume of dependable training data, which is not always available, to accurately fuse one or more satellite images with additional information. One or more examples of the disclosed techniques for merging remote sensor data can be viewed as a hybrid of the existing techniques and methods described above. For example, one or more data fusion techniques can represent a hybrid graph-based approach (related to traditional image processing techniques) that allows terrain data to be used (similar to the existing machine learning approaches) but without the need for large amounts of dependable training data.

One or more examples of this technical solution can include a graph-based approach designed to improve the resolution of a coarse dataset to achieve both local smoothness and physical consistency (e.g., accuracy). In some examples, this technical solution can estimate a model that comports with one or more graph signals and determine an optimal graph structure based on one or more the characteristics of the remote sensor data. For example, by fusing multimodal datasets from diverse sources of information, including terrain characteristics, this technical solution enhances the resolution of coarse satellite images. And the examples disclosed herein provides enhanced sensor data having improved accuracy compared to one or more geostatistical strategies, including but not limited to, kriging and nearest-neighbor interpolation. In some examples, this technical solution can enhance sensor data with an approximate reduction of 8.4% in mean squared error compared to Kriging and nearest-neighbor interpolation. In some examples, this technical solution reduces errors by enhancing sensor data according to one or more relationships between the signals of interest (e.g., sensor data) and one or more auxiliary variables (e.g., terrain information).

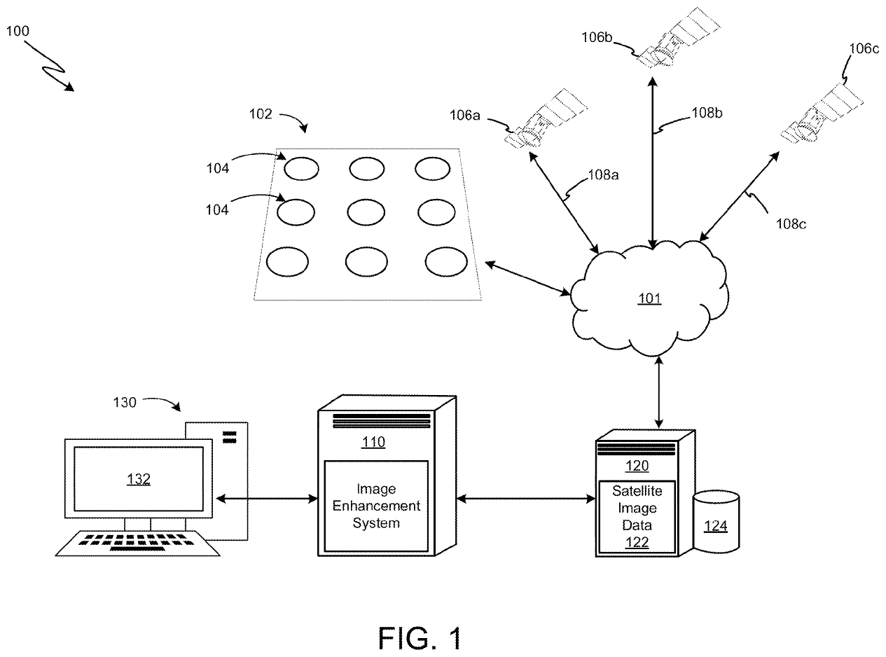

FIG. 1 depicts an example system according to this disclosure. As illustrated by way of example in FIG. 1, a system 100 can include at least a network 101, a geographical region 102, a first satellite-based sensor 106A, a second satellite-based sensor 106B, a third satellite-based sensor 1060, an image enhancement system 110, a remote sensor data system 120, and a client system 130.

The network 101 can include any type or form of network. The geographical scope of the network 101 can vary widely and the network 101 can include a body area network (BAN), a personal area network (PAN), a local-area network (LAN), e.g., Intranet, a metropolitan area network (MAN), a wide area network (WAN), or the Internet. The topology of the network 101 can be of any form and can include, e.g., any of the following: point-to-point, bus, star, ring, mesh, or tree. The network 101 can include an overlay network which is virtual and sits on top of one or more layers of other networks 101. The network 101 can be of any such network topology as known to those ordinarily skilled in the art capable of supporting the operations described herein. The network 101 can utilize different techniques and layers or stacks of protocols, including, e.g., the Ethernet protocol, the Internet protocol suite (TCP/IP), the ATM (Asynchronous Transfer Mode) technique, the SONET (Synchronous Optical Networking) protocol, or the SD (Synchronous Digital Hierarchy) protocol. The ‘TCP/IP Internet protocol suite can include application layer, transport layer, Internet layer (including, e.g., IPv6), or the link layer. The network 101 can include a type of a broadcast network, a telecommunications network, a data communication network, or a computer network.

The geographical region 102 can include a specified portion of land to collect one or more sensor datasets used to generate a corresponding one or more models corresponding to the geographical region 102. For example, the geographical region 102 can include an area of land defined by a set of geographic coordinates and that is associated with one or more sensor dataset(s) for one of more physical properties at the geographical region 102. For example, the geographical region 102 can include one or more in-situ sensors 104 located at a plurality of locations in the geographical region 102. The in-situ sensors 104 can collect one or more physical metrics associated with the geographical region 102. For example, each of the in-situ sensors can detect one or more metrics (e.g., collect one or more environmental measurements) indicative of a physical property at the geographical region 102. More specifically, the in-situ sensors 104 can collect each of the metrics with a predetermined temporal resolution (e.g., at a predetermined frequency) and with a spatial resolution based on the number of in-situ sensors 104 present in the geographic region 102. For example, the in-situ sensors 104 can include sensor devices at the surface of or at least partially buried at one or more particular locations in the geographic region and each configured to detect one or more of an atmospheric property (e.g., temperature, humidity, atmospheric pressure, windspeed, air quality, etc.), a hydrological property (e.g., water levels, ground water content, precipitation, etc.) or a moisture property (e.g., soil moisture).

The first satellite-based sensor system 106A can include an earth orbiting satellite oriented toward the geographic region 102 and configured to detect one or more physical properties at one or more locations in the geographical region 102. For example, the first satellite-based sensor system 106A can include one or more of an infrared sensor, a radar receiver, an active radar sensor, a moisture sensor, radiometric brightness temperature sensor, one or more optical sensors and/or digital imaging sensors, one or more surface/cloud temperature sensors, or any other sensor, instruments, receivers, and so on described herein. In some examples, the first satellite-based sensor system 106A can include a remote soil moisture sensor configured to collect soil moisture measurements with a predetermined spatio-temporal resolution or at a first granularity (e.g., according to a predetermined spatial resolution and at predetermined rate over time).

For example, the first satellite-based sensor system 106A can include a passive radiometer sensor (e.g., an L-Band radiometer operating at 1.41 Ghz) that is configured to collect measurements of soil moisture for a geographic region (e.g., geographic region 102) and with a first specific spatio-temporal resolution (e.g., a spatial resolution of 0.08 degrees or approximately 9 km and with a temporal resolution of 3-5 days). In some examples, the first satellite-based sensor system 106A can include an active radar sensor (e.g., an L-Band radar, a C-Band Synthetic Aperture Radar (SAR), etc.) that is configured to collect measurements of soil moisture for a geographic region (e.g., geographic region 102) using a second predetermined spatio-temporal resolution, which may differ from the first resolution associated with a radiometer sensor of the first satellite-based sensor system 106A (e.g., a spatial resolution of 0.08 degrees or approximately 40 km and with a temporal resolution of 30 days). For example, the first satellite-based sensor system 106A can include one or more of an active radar sensor and a passive radiometer sensory that are configured to collect measurements of vegetation water content and vegetation optical depth.

The first satellite-based sensor system 106A can include a first wireless communication link 108A to transmit one or more metrics (e.g., remote sensor dataset(s)) indicative of a physical property at the geographic region 102 to the remote sensor data system 120 via the network 101. The first wireless communication link 108A and the first satellite-based sensor system 106A can communicate a new set of one or more metrics (e.g., new satellite-based sensor data) using a frequency determined from the temporal resolution of the corresponding metrics. In some examples, the first satellite-based sensor system 106A and the first wireless communication link 108A can be configured to transmit metrics indicative of soil moisture at a geographic region every 3-5 days.

The second satellite-based sensor system 106B can include an earth orbiting satellite oriented toward the geographic region 102, which is configured to detect one or more physical properties at one or more locations in the geographic region 102. For example, the second satellite-based sensor system 106B can include one or more of an infrared sensor, a radar receiver, an active radar sensor, a moisture sensor, radiometric brightness temperature sensor, one or more optical sensors, one or more digital imaging sensors, surface/cloud temperature sensors, or any other sensor, instruments, receivers, and so on described herein. In some examples, the second satellite-based sensor system 106B can include one or more sensors configured to collect measurements of a land surface temperature of a geographic region using a predetermined spatio-temporal resolution (e.g., with a spatial resolution of 0.00898 Degrees or approximately 1 km and a temporal resolution of 1-2 days). For example, the second satellite-based sensor system 106B can include a Moderate Resolution Imaging Spectroradiometer (MODIS) sensor system configured to collect land surface temperature data for a geographic region corresponding to a model generated according to the present implementations. In some embodiments, the second satellite sensor system 106B can include one or more evapotranspiration (ET) image sensors configured to measurements of evapotranspiration across a geographic region with a specific spatio-temporal resolution (e.g., at a spatial resolution of approximately 70 meters and a temporal resolution of 3-5 days).

The second satellite-based sensor system 106B can include a second wireless communication link 108B configured to transmit one or more metrics indicative of a physical property at a geographic region to the remote sensor data system 120 via the network 101. The second wireless communication link 108B and the second satellite-based sensor system 106B can be configured to communicate the metrics (e.g., the new satellite-based sensor data) at a frequency based on the temporal resolution for the corresponding metrics. For example, the second satellite-based sensor system 106B and the second wireless communication link 108B can be configured to transmit one or more metrics indicative of land surface temperature at a geographic region every day, which the second satellite-based sensor system 106B collects every 24 to 48 hours (e.g., with a temporal resolution of 24 to 48 hours).

The third satellite-based sensor system106C can include an earth orbiting satellite oriented toward the geographic region 102 and configured to detect one or more physical properties. For example, the third satellite-based sensor system 106C can include one or more of an infrared sensor, a radar receiver, an active radar sensor, a moisture sensor, radiometric brightness temperature sensor, one or more optical sensors, one or more digital imaging sensors, surface/cloud temperature sensors, or any other sensor, instruments, receivers, and so on described herein. In some examples, the third satellite-based sensor system 106C can include one or more altimeters configured to collect topographic measurements of the earth's surface, including across a specific geographic region and with a corresponding spatio-temporal resolution (e.g., with a spatial resolution of 30 meters and a temporal resolution of 1-10 years), which may differ from the spatio-temporal resolution of the measurements collected by the first and second satellite-based sensor systems 106A and 106B.

The third satellite-based sensor system 106C can include a third wireless communication link 108C configured to transmit one or more metrics indicative of a physical property at a geographic region to the remote sensor data system 120 via the network 101. The third wireless communication link 108C and the third satellite-based sensor system 106C can be configured to communicate and collect one or more metrics (e.g., the new satellite-based sensor data) at a frequency based on the temporal resolution of the one or more metrics. For example, the third satellite-based sensor system 106C and the third wireless communication link 108C can be configured to transmit, every 365 days, one or more metrics indicative of land surface altitude (e.g., topology) at a geographic region, which the second satellite-based sensor system 106B collects every 1-5 years (e.g., with a temporal resolution of 1-5 years).

Other examples of the implementations disclosed herein can include any number of satellite-based sensor systems, which may each be configured to collect one or more measurements of a corresponding physical property for a geographical region, and the number of satellite-based sensor systems is not limited to the three exemplary satellite-based sensor systems 106A-C illustrated in FIG. 1. For example, the system 100 can include one or more different communication channels (e.g., different from communication channels 108A-C), including one or more different data refresh rates (e.g., of the communication channels 108A-C) that can be determined according to the frequency of each new dataset collected by the corresponding sensor. For example, the system 100 can include one or more additional communication channels with a corresponding data refresh rate, including, but not limited to, one or more data communication channels with a refresh rate of evapotranspiration data collected by the corresponding satellite-based sensor system and/or one or more data communication channels for a plurality of in-situ soil moisture sensors configured with a data refresh rate of every 8 hours.

The image enhancement system 110 can generate, modify, and/or transform one or more models for a physical property at a geographic region to cause a user interface to present (e.g., graphically display) a corresponding view of the geographic region. In some examples, the image enhancement system 110 can generate a first model corresponding to the geographic region 102, including one or more first node metrics at a first granularity (e.g., a first spatio-temporal resolution) in the geographic region 102. Accordingly, the system 110 can include one or more first node metrics each corresponding to a respective quantitative value of a first physical property (e.g., soil moisture) at a first location in the geographic region 102. Accordingly, each of the first node metrics can respectively indicate a first physical property, including, but not limited to, the soil moisture or air quality, at a first location of the geographic region 102. For example, the image enhancement system 110 can generate a model for the soil moisture of the geographic region 102 using one or more metrics indicative of a soil moisture in the geographical region 102 collected at different granularities (e.g., collected by the first satellite-based sensor system 106A). In some examples, the remote sensor data system 120 can transmit a satellite imagery data 122, or a portion thereof, to the image enhancement system 110 for use in generating one or more models corresponding to the geographical region 102.

More generally, the image enhancement system 110 can generate an estimation of the physical property of a first model having a greater, or enhanced, granularity (e.g., one or more enhanced estimation values having an increased granularity). The image enhancement system 110 can additionally receive one or more second node metrics, each corresponding to a respective quantitative value of a second physical property at the geographical region 102. In some examples, the image enhancement system 110 can generate a second model corresponding to the geographic region 102 using the one or more second node metrics and at the second granularity (e.g., a second spatio-temporal resolution), which is greater than the first granularity in the geographic region 102. Moreover, each of the second node metrics can respectively indicate a second physical property (e.g., a land surface temperature) at a second location, or one or more subregions, in the geographic region 102.

In some examples, the image enhancement system 110 can modify the second model to include one or more connection metrics at the second granularity, each of the connection metrics respectively indicating the second physical property (e.g., land surface topology, evapotranspiration, etc.) between one or more corresponding second node metrics. Additionally, the image enhancement system 110 can cause, based on the connection metrics, a user interface to present a view of the geographic region 102 with one or more subregions at the second granularity (e.g., the greater spatio-temporal resolution of the second model), including corresponding quantitative indications of the first physical property (e.g., soil moisture, air quality, etc.) at each subregion.

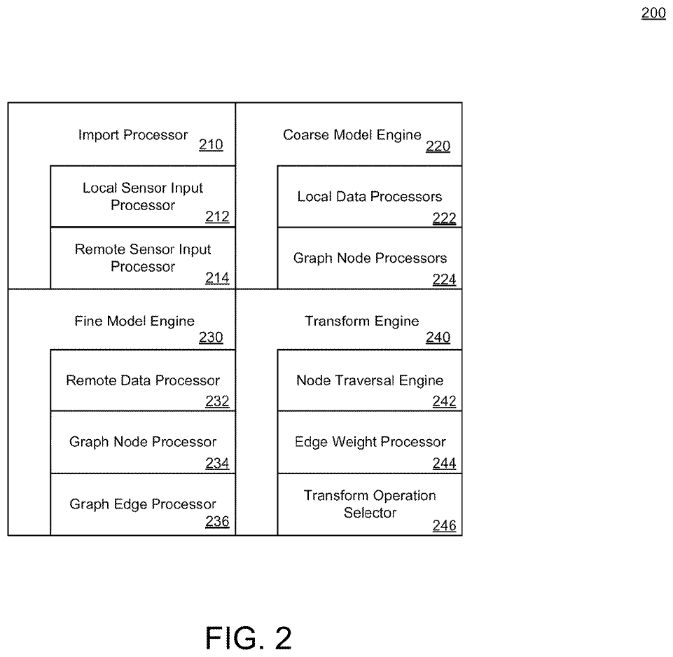

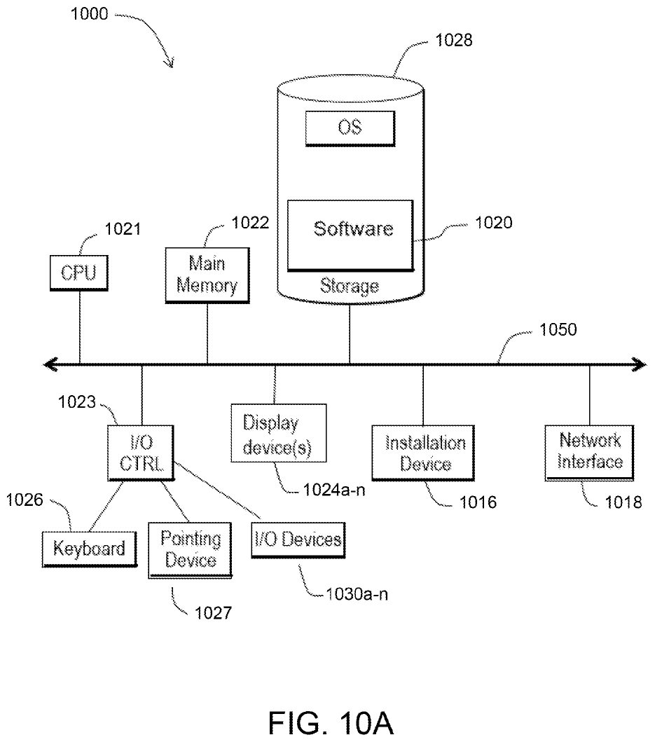

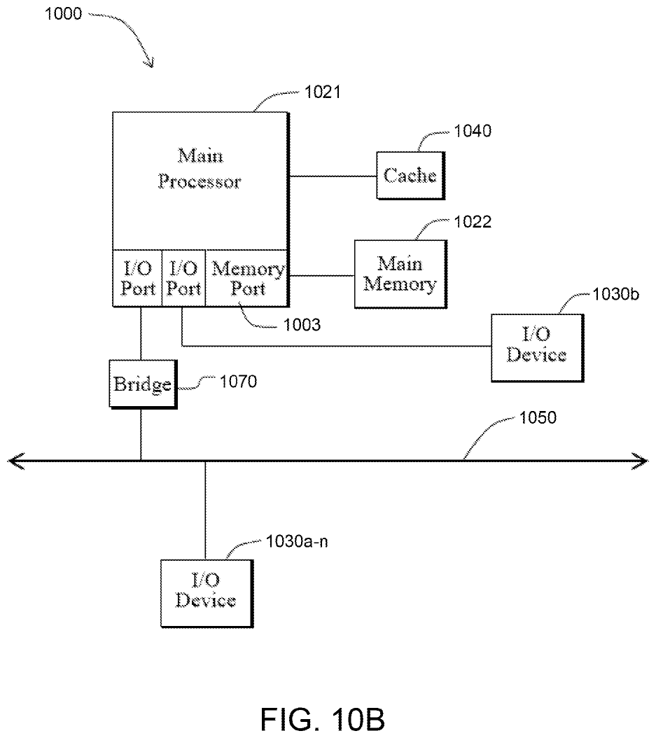

The image enhancement system 110 can include or utilize at least one processing unit or other logic devices including, but not limited to, a programmable logic array engine or a module configured to communicate with one another or other resources or databases (e.g., client system 130, remote sensor data system 120, remote sensor database 124, and/or the computing device 1000 depicted in FIGS. 10A and 10B). Similarly, the image enhancement system 110, and any of its components depicted in FIG. 2, can include any suitable hardware and/or software elements, including, but not limited to, one or more processors, logic devices, or circuits and/or corresponding software modules.

The remote sensor data system 120 can receive, via network 101, one or more metrics collected by the satellite-based sensor systems 106A-C and/or the in-situ sensors 104, which indicate a physical property at a geographical region. The remote sensor data system 120 can include satellite imagery data 122, and a remote sensor database 124. The remote sensor data system 120 can receive, store, organize, and transmit (e.g., to the image enhancement system 110).

The remote sensor database 124 can store one or more remote sensor values (e.g., one or more node metrics) received by the remote sensor data system 120. For example, the remote sensor database 124 can store each of the remote sensor values (e.g., each of the one or more node metrics) that the remote sensor data system 120 receives from the in-situ sensors 104, the first satellite-based sensor system 106A, the second satellite-based sensor system 106B, or the third satellite-based sensor system 106C. The remote sensor database 124 can store each remote sensor value (e.g., each of the one or more node metrics) with the corresponding geographic region or sub-region (e.g., the corresponding location associated with the remote sensor values), which may comprise a graph, image, map, or other view depicting the remote sensor values at the corresponding geographic region (e.g., satellite imagery data 122).

The satellite imagery data 122 can include one or more different metrics (e.g., one or more sets of node metrics or remote sensor values) received from the satellite-based sensor systems 106A-C, which respectively indicate one or more corresponding physical properties at the geographic region 102. In some examples, the satellite imagery data 122 includes one or more different node metrics at a corresponding granularity (e.g., spatio-temporal resolution) in a corresponding geographical region. For example, the satellite imagery data 122 can comprise a graph of soil moisture values (e.g., one or more first node metrics) at a first (e.g., coarse) granularity in the geographic region 102. In some examples, the satellite imagery data 122 can comprise a graph of land surface temperature, including one or more metrics at a second granularity in the geographic region 102, which second granularity is greater than the first granularity (e.g., a greater spatio-temporal resolution).

The client system 130 can include or execute on one or more processors or computing devices and/or communicate via a network (e.g., network 101) including, for example, to communicate with the image data processing system 110. The client system 130 includes a display 132, which can be used to present information to the user of the client system 130, which may include information that the client system 130 received from the image data processing system 110. For example, the client system 130 may receive from the image data processing system 110, a view of a geographic region including one or more quantitative indications of a first physical property at the geographic region and graphically present the received view on a user interface. For example, the display 132 can include a liquid crystal display (LCD), a light-emitting diode (LED) display, an organic light-emitting diode (OLED) display, or the like. The display 132 can receive, for example, capacitive or resistive touch input. The display 132 can be housed at least partially within the client system 130.

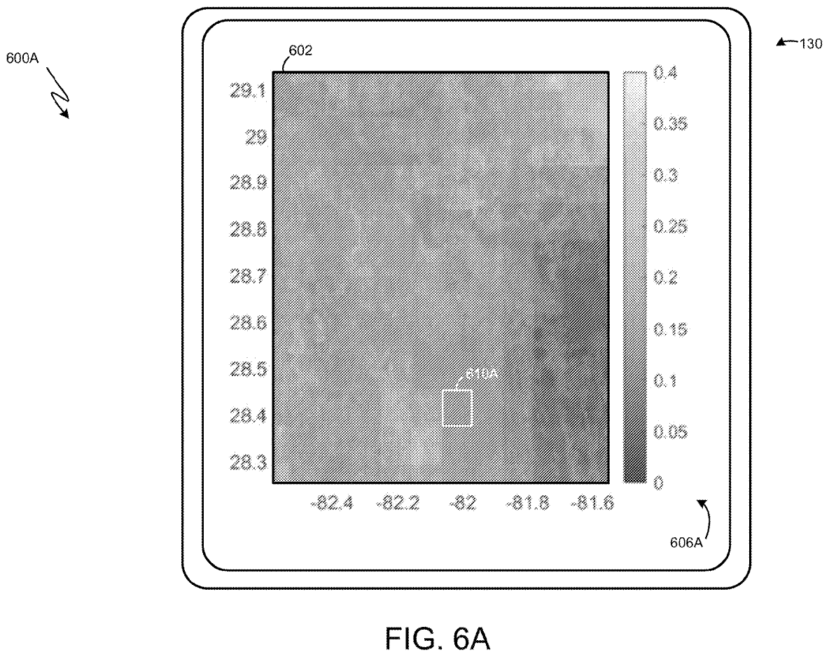

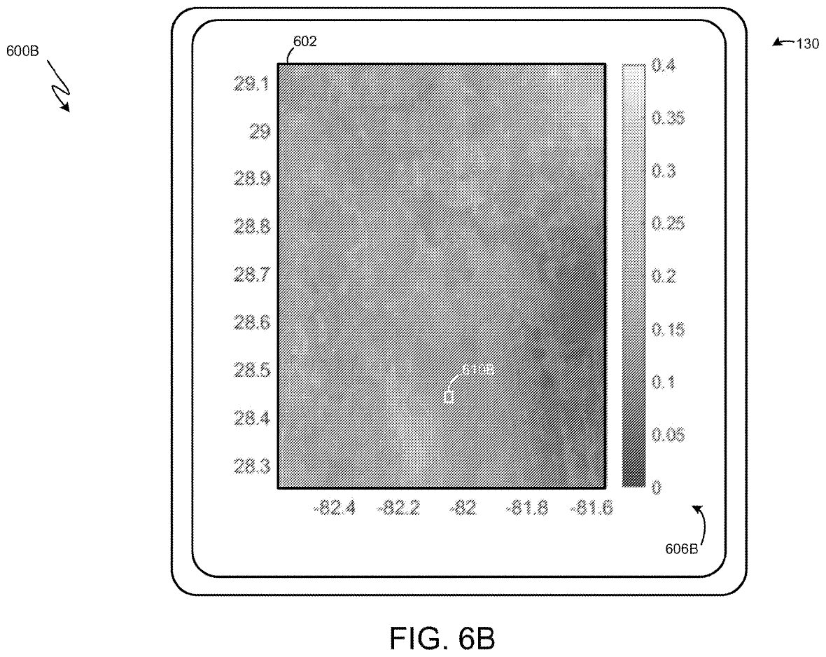

The client system 130 can include or utilize at least one processing unit or other logic devices including, but not limited to, a programmable logic array engine or a module configured to communicate with one another or other resources or databases (e.g., remote sensor data system 120 and/or remote sensor database 124). In some examples, the client system 130 can present, via the display 132, one or more views of the geographic region 102 including one or more subregions at the second granularity (e.g., subregions 610C, 620C, and 630C depicted in FIGS. 6A-C), each of the subregions including corresponding quantitative indications of the first physical property at the second location. For example, the client system 130 and/or display 132 can present one or more of the views, including one or more subregions, illustrated in FIGS. 6A-6C.

FIG. 2 depicts an example image enhancement system architecture according to this disclosure. As illustrated by way of example in FIG. 2, an image enhancement system architecture 200 can include at least an import processor 210, a coarse model engine 220, a fine model engine 230, and a transform engine 240.

The import processor 210 can receive and process the sensor datasets transmitted to, and used by, the image enhancement system 200, including, for example, one or sensor datasets corresponding to a geographical region (e.g., one or more sensor values collected by in-situ sensors 104 and/or one or more of the satellite-based sensor systems 106A-C). In some examples, the remote sensor data system 120 transmits the one or more sensor datasets, or sensor values, to the image enhancement system 200 as one or more inputs to the import processor 210. Accordingly, the import processor 210 can include the hardware and/or software modules used to perform electronic communications between the image enhancement system 110 and the remote sensor data system 120 (e.g., electronic communication via a network, including according to the description of the network 101 provided above with reference to FIG. 1). As depicted in FIG. 2, the import processor 210 can include a local sensor input processor 212, and a remote sensor input processor 214.

The local sensor input processor 212 can receive and process one or more local sensor values that are received by the image enhancement system. In some examples, the local sensor input processor 212 can receive or process one or more local sensor datasets (e.g., values collected by in-situ sensors 104), which are collected at a corresponding granularity in a corresponding geographic region (e.g., geographic region 102). For example, the image enhancement system can include a first physical property corresponding to at least one of an atmospheric property, a hydrological property, or a moisture property. For example, the system can obtain, via one or more sensors located at the geographic region (e.g., geographic region 102), the first node metrics. In further examples, the system can include each of the one or more sensors (e.g., in-situ sensors 104) placed at the first location of the geographic region corresponding to one or more models generated by the system (e.g., the geographic location 102).

The remote sensor input processor 214 can receive and process one or more remote sensor values received by the image enhancement system (e.g., from the remote sensor data system 120). In some examples, the remote sensor input processor 214 can receive and process remote sensor data that indicates the first physical property, including, but not limited to, a soil moisture. In some examples, the system can include a second physical property corresponding to at least one of a topological property, a geological property, or an altitude property.

For example, the system 200 can obtain, via one or more sensors located remote from the geographic region (e.g., one or more of the first, second, and/or third satellite-based sensor systems 106A-C) one or more second node metrics indicating the second physical property (e.g., a land surface topology, a geological composition, an altitude, etc.) at the geographic region. For example, the system can include the one or more sensors located remote from the geographic region corresponding to one or more satellites (e.g., the first, second, and/or third satellite-based sensor systems 106A-C) each oriented toward the geographic region and configured to detect one or more physical properties (e.g., a second physical property).

The coarse model engine 220 can generate a first model with one or more first node metrics at a first granularity in the geographic region 102. As depicted in FIG. 2, the coarse model engine 220 can include the local data processors 222 (also referred to herein as a coarse data processors 222), and a graph node processors 224 (also referred to herein as a coarse graph node processors 222).

The local data processors 222 can receive and process one or more coarse sensor values (e.g., coarse soil moisture data collected by a plurality of in-situ sensors) to generate a first model, with a coarse resolution (e.g., a first granularity) in the geographic region 102. The coarse sensor values processed by the local data processors 222 can each respectively indicate a first physical property at a corresponding location, or subregion, in the geographic region 102. For example, the local data processors 222 can process one or more local soil moisture sensor values collected at a coarse resolution in the geographical region 102 to use in generating a coarse model for a geographic region (e.g., the geographic region 102). For example, the image enhancement engine may receive (e.g., via user input) parameters, including, but not limited to, geospatial coordinates, that define a geographical region to be used in generating a coarse model and the local data processors 222 may identify, based on the received parameters, one or more corresponding local sensor values or local sensor datasets for the defined geographical region.

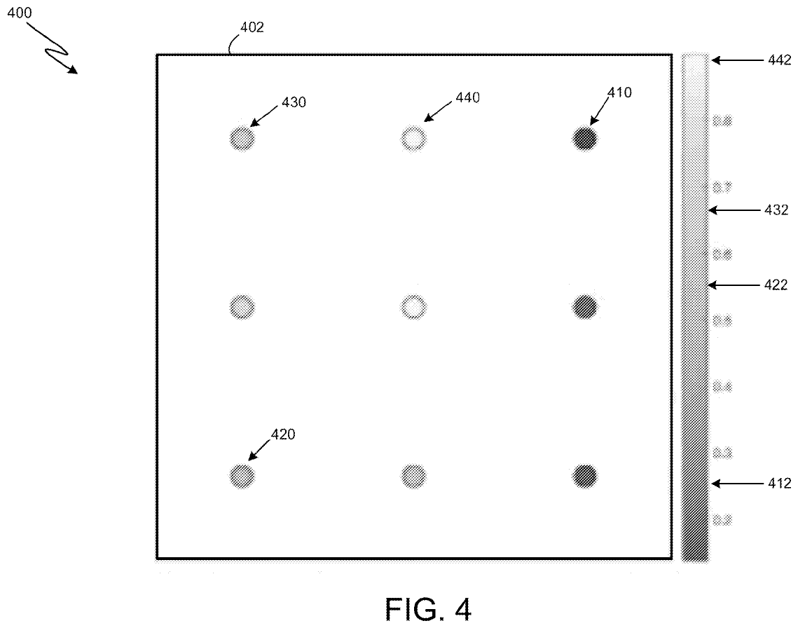

The graph node processors 224 can generate one or more node metrics of a coarse model corresponding to a geographic region. The graph node processor 224 can use the one or more sensor values or a local sensor dataset (e.g., in-situ soil moisture data) to generate each node metric of the coarse model generated by the coarse model engine 220. More specifically, the graph node processor 224 can generate, according to the granularity (e.g., spatio-temporal resolution) of the local sensor dataset (e.g., spatio-temporal resolution of the in-situ soil moisture dataset), one or more first node metrics, each of the node metrics respectively indicative of a first physical property (e.g., soil moisture) at a first location of the geographic region 102 (see nodes 410, 420, 430, and 440 of graph 400 depicted in FIG. 4). Thus, this technical solution can interface with one or more sensors or obtain input from the output of one or more sensors at one or more distinct spatio-temporal resolutions corresponding to those sensors, to provide at least a technical improvement to identify physical property of a geographic region at a degree of granularity and a degree of responsiveness beyond the capability of manual processes to achieve.

The fine model engine 230 can generate one or more fine resolution models (e.g., a second model) using one or more second node metrics at a fine resolution (e.g., at a greater granularity than the model generated by the coarse model engine 220) and corresponding to a geographic region. As depicted in FIG. 2, the fine model engine 230 can include a remote data processor 232, a graph node processor 234, and a graph edge processor 234.

The remote data processor 232 can receive and process one or more remote sensing datasets each with a corresponding resolution and collected by a corresponding remote sensors, which can each be used to generate a second model with a fine-resolution greater than the resolution of one or more coarse models. For example, the remote data processor 232 can receive and organize each of the one or more remote sensor datasets, which can be received from the remote sensor data system 120, including, but not limited to, one or more remote sensor datasets (e.g., node metrics) with one or more corresponding resolutions, which are each collected by one or more of the satellite-based sensor systems 106A-C.

For example the remote data processor 232 can process one or more sensor datasets with one or more corresponding resolutions, including, but not limited to, a sensor dataset for a land surface temperature with a first fine resolution and collected by one or more of the satellite-based sensor systems 106A-C. In some examples, the land surface temperature dataset may have a first fine resolution that is irregular and may vary over one or more locations in the geographic region 102. In some examples, the fine model engine 230 can receive (via the remote data processor 232) a land surface temperature dataset having a first fine resolution or first enhanced granularity over the geographical region 102. In some examples, the remote sensor datasets processed by the remote data processor 232 can each respectively indicate one or more different physical properties and at a corresponding granularity (with the corresponding resolution), including, in some examples, one or more remote datasets with different resolutions, which may each differ from any of the one or more granularities of the one or more remote datasets processed by the remote data processor 232. For example the remote data processor 232 may receive both a first remote dataset for a land surface temperate at a first enhanced granularity that is greater than a coarse granularity and a second remote dataset for an evapotranspiration value at a second enhanced granularity, which is greater than the first enhanced granularity.

In some examples, the remote data processor 232 may receive parameters, or geospatial coordinates, which define the geographical region 102 corresponding to the node metrics to use for generating the fine resolution model. Accordingly, the remote data processor 232 may identify, based on the received parameters, one or more corresponding remote sensor values or remote sensor datasets in the corresponding geographical region.

The following defines one or more concepts related to GSP. Consider a weighted, undirected, interconnected graph G=(V,E,W). This graph comprises a finite set of vertices V=ν₁, . . . , ν_{N}, an edge set E which is a subset of the Cartesian product of V×V, and a weight matrix W∈R^{N×N}. Each entry, wᵢⱼ, in the weight matrix quantifies the affinity between the corresponding nodes νᵢ and νⱼ. If (vᵢ, vⱼ) is not an element of E, the weight wᵢⱼ is assigned a value of 0. As the graph is undirected, the weight matrix is symmetric, W=WT. The neighborhood N(νᵢ) of a node vi is the set of nodes with a direct edge connection to νᵢ. The degree of a node is the summation of the weights of one or more connected nodes, which can be represented by a degree matrix D, which can be defined as the diagonal matrix D=Diag(W1a). For example, this technical solution can use the combinatorial graph Laplacian L=D−W and one or more graph constructions, which may cause one or more graphs to be connected.

In some examples, this technical solution can enhance a soil moisture (SM) dataset, which can be used to assess the accuracy of one or more fusion techniques described herein. For example this technical solution can be used to enhance a soil moisture dataset, which can have a coarse resolution and can include one or more gaps in the dataset, which can be caused by one or more of a change in a satellite orbit, radio-frequency interference (RFI), and one or more physical limitations of the antennas of the soil moisture sensors. Moreover, soil moisture data can be associated with one or more climate metrics. For example, this technical solution can determine one or more graph weights from one or more of a terrain, temperature, and vegetation data and generate enhanced soil moisture data, which may capture one or more local physical phenomena.

In one or more examples, this technical solution can be used to enhance remote sensed datasets generated by NASA's Soil Moisture Active Passive (SMAP) radiometer and the Moderate-Resolution Imaging Spectroradiometer (MODIS) aboard the Terra and Aqua satellites. For example, this technical solution can be well suited for use with SMAP data because it includes an L-band radiometer that can effectively penetrate vegetation and image soil moisture. More generally, in some examples, this technical solution can be used to enhance coarse satellite soil moisture measurements, drawn from the SMAP mission, which can use a fine-resolution land surface temperature data (LST) collected by MODIS, which can be used in conjunction with either a vegetation dataset, a terrain dataset, or both. For example, a signal at each graph node can represent soil moisture measured on a 36 km grid from SMAP, which can include data drawn from a global daily EASE-Grid SM (0-5 cm depth) in cm³/cm³ and further derived from brightness temperatures recorded over a specified period of time. The graph edge weights can be obtained from one or more differences in terrain elevation and/or variations in a land surface temperature (LST) at a corresponding granularity or grid size. LST variations were chosen as supplementary data because daily temperature fluctuations and vegetation presence significantly impact soil moisture. A gradient corresponding to the altitude difference between neighboring nodes can establish a weighted norm.

The graph node processor 234 can generate, according to one or more remote sensor datasets (e.g., remote datasets indicative of a land surface temperature, an evapotranspiration quality, an elevation, etc.) one or more second nodes of a second model, which can correspond to the output provided by the fine model engine 230. For example, the graph node processor 234 can generate, according to one or more remote datasets and the corresponding resolutions, one or more second node metrics (e.g., of a second model) with an enhanced resolution or a second granularity. For example, the second nodes can have a second granularity based on a resolution of the one or more resolutions for the remote sensor datasets, including, but not limited to, choosing the resolution with the greatest spatial granularity, choosing a resolution corresponding to the most uniform spatial distribution for the sensor dataset, and/or a resolution requiring the least computational resources (e.g., the resolution with the greatest computational efficiency). Additionally, each of the one or more second node metrics can indicate a respective value of one of a second physical property at the corresponding location (e.g., a land surface temperature of each second node). In one or more examples, one remote dataset may include a substantially fine resolution for an elevation dataset indicated by the second node metrics but, the enhanced resolution, or second granularity, of the second node metrics can be determined by converting the substantially fine resolution to a uniform resolution or the second granularity associated with the second node metrics and, consequently one or more graphs generated by the system 200.

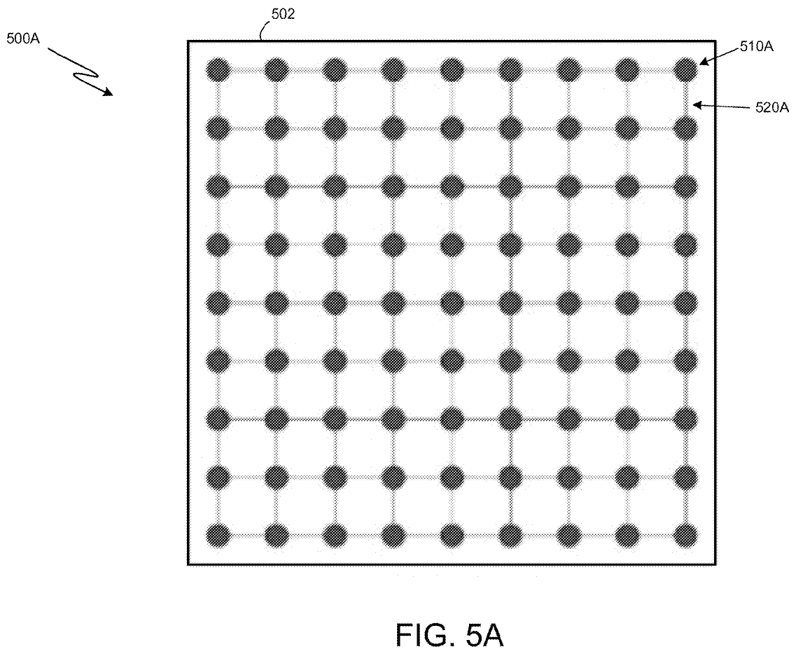

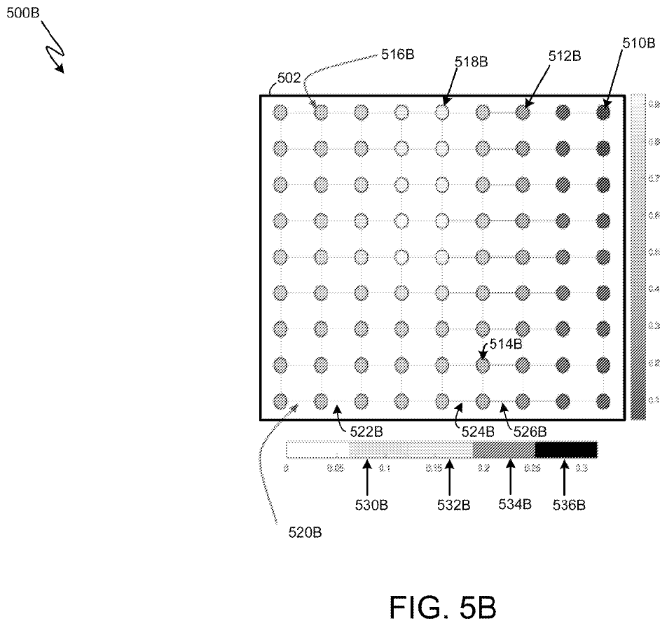

The graph edge processor 234 can generate one or more connection metrics at the second granularity of the one or more second metrics and that may be determined based on the resolutions for the one or more remote sensor datasets. For example, each of the connection metrics generated by the graph edge processor 234 may respectively indicate a corresponding physical property (e.g., a third physical property) between one or more corresponding second node metrics and that may be correlated to each of the first and second physical properties (e.g., the physical properties that are respectively indicated by the first and second node metrics). For example, the graph edge processor 234 can determine, using one or more remote sensor dataset(s) at the second granularity, indicating an evapotranspiration property (e.g., plant coverage), the one or more connection metrics between corresponding one or more corresponding second node metrics. Accordingly, in some examples, the graph edge processor 234 can modify the second model output by the graph node processor 234 to include the one or more connection metrics generated by the graph edge processor 234 (see, e.g., graph edge 520A depicted in FIG. 5A).

The transform engine 240 can perform one or more transform operations corresponding to a respective interpolation operation from the first granularity (e.g., the granularity of the first model) to the second granularity (e.g., the granularity of the second model). As depicted in FIG. 2, the transform engine 240 can include a node traversal engine 242, an edge weight processor 244, a transform operation selector 246, and a transform operation processor 248.

The node traversal engine 242 can, with edge weight processor 244 and transform operation processor 248, determine a weighted aggregate of the one or more node metrics according to the corresponding connection metrics (e.g., edge weights), to use the weighted aggregate in generating one or more model metrics and/or one or more output node metrics (e.g., to perform one or more transform operations). For example, the node traversal engine 242 (and/or the transform operation engine 248) can determine a weighted aggregation of a first output from a first transform operation and a second output of a second transform operation to generate one or more model metrics for each of the second locations at the geographical region 102. More specifically, the transform operation engine 248 and the node traversal engine 242 can operate in tandem to determine the weighted aggregation for the first output of the first transform operation (e.g., traverse the one or more second node metrics according to the weighted edges and preforming the first transform operation at each second node) and the second output for the second transform operation (e.g., traverse the one or more second node metrics according to the weights of each corresponding connection metric and preform the second transform operation at each second node).

The edge weight processor 244 can generate a weight for each of the one or more connection metrics between one or more corresponding second node metrics, according to a correlation between the first and second physical properties and, in some examples, without regard to spatial similarity of one or more second nodes. For example, the edge weight processor 244 can generate, using one or more remote sensor dataset(s) at the second granularity and measuring the second physical property (e.g., evapotranspiration), the weights of each connection metric between the corresponding one or more second node metrics. For example, the edge weight processor 244 can generate a greater edge weight for a connection metric between two second node metrics associated that are similar with regard to the third physical property (e.g., two second node metrics associated with connection metric(s) with similar evapotranspiration properties) compared to a plurality of second node metrics that are dissimilar with regard to the third physical property (e.g., two or more second node metrics associated with highly dissimilar evapotranspiration properties). Accordingly, the edge weight processor 244 can generate weights for each of the one or more connection metrics based on the similarity (or dissimilarity) of the corresponding one or more second node metrics (e.g., comparing associated evapotranspiration, topological, and/or geographical data, at the corresponding location(s)). In some examples, the edge weight processor 244 can generate one or more weights of one or more connection metrics using a combination of one or more static variables and one or more time varying variables. For example, the edge weight processor 244 can generate a weight of one or more connection metrics using one or more static variables, including one or more of an altitude dataset, a permanent mask for land, water, forest, and urban areas, among others. As another example, the edge weight processor 244 can generate a weight of one or more connection metrics that can provide an enhanced (e.g., predetermined) accuracy of one or more remote sensor models, which can be based on the weights generated by the edge weight processor 244 for each connection metrics and according to one or more dynamic variables, including but not limited to, a land surface roughness, a precipitation, a vegetation cover, and a soil temperature, among others. For example, the image enhancement system 200 can output an enhanced image map of the first physical property (e.g., soil moisture) with an accuracy of the first physical property at the second, enhanced, granularity, based on one or more edge weights output by the edge weight processor 244 for each connection metric (e.g., each map edge) of the one or more connection metrics between each one or more corresponding node metrics.

The transform operation selector 246 can determine a transform operation, of a plurality of transform operations, which satisfies a threshold indicative of an accuracy at the second granularity. The transform engine 240 (e.g., and/or transform operation selector 246) can include a plurality of transform operations each corresponding to a respective interpolation operation from the first granularity to the second granularity. Accordingly, the transform operation selector 246 can select from among the plurality of transform operations, a transform operation that satisfies a threshold indicative of an accuracy at the second granularity. And the transform operation selector 246 can select a transform operation with the threshold indicative of an accuracy of a transformation of the first node metrics at the first granularity to the second node metrics at the second granularity. For example, the transform operation selector 246 can select a transform operation that satisfies the threshold, which is indicative of an accuracy of a transformation of the first node metrics, which indicate a soil moisture at the first (e.g., coarse) granularity to the second node metric, which indicate a land surface temperature at the second granularity (e.g., greater than the first granularity).

The transform operation processor 248 can perform one or more transform operations selected by (e.g., output from) the transform operation selector 246. In some examples, the transform operation processor 248 can generate, from the second node metrics and according to one or more model metrics at the second granularity, one or more output node metrics corresponding to the quantitative indications, each of the model metrics indicative of a respective combination of a plurality of transform operations at the second location. For example, the transform operation processor 248 can generate the one or more output node metrics corresponding to the quantitative indications of the soil moisture at the second location (e.g., at one or more subregions at the second granularity, each of the subregions including quantitative indications of the soil moisture at the second location and/or at the fine spatial resolution).

More specifically, the transform operation processor 248 can use a weighted aggregation of a first output of a first transform operation and a second output of a second transform operation to generate the model metrics for each of the second locations. For example, the transform operation processor 248 can use a weighted aggregation of a first output of a first linear operation and a second output of a quadratic operation. The system 200 can include a plurality of different transform operations, each corresponding to interpolation at the second, enhanced, granularity. The transform operation selector 246, therefore, can select the first transform operation by choosing a simpler operation that may save computational resources, which can include a linear function. For example, the transform operation selector 246 can select, for the first transform operation, a linear structural equation model. For example, the transform operation selector 246 can select a second transform operation of a plurality of different transform operations, which can be a quadratic function associated with a computational cost that is below a threshold (e.g., with a computational requirement less than a maximum). Accordingly, in some examples, the transform operation selector 246 can be configured to reduce, or minimize, the computational resources used by the transform operation processor 248.

In some examples, the transform operation processor 248 can generate the model metrics for each of the second locations according to the weighted aggregation, each of the model metrics generated according to a determination by the transform operation selector 246 that the first transform operation does not satisfy the threshold indicative of the accuracy at the second granularity.

In some examples, after the transform operation processor 248 has completed each of the one or more transform operations to generate a graph enhancement network (e.g., satisfying a threshold indicative of an accuracy at the second granularity), the image enhancement system 200 can cause a user interface (e.g., client display 132) to present a view of the geographic region 102 including one or more subregions at the second granularity, each of the subregions including corresponding quantitative indications of the first physical property at the second location (e.g., the first subregion 620C and second enhanced graph value 622C, each depicted in FIG. 6C).

For example, this technical solution can improve the resolution of a coarse satellite image by employing higher-resolution information that is related to the physical phenomena under investigation. In one example of this technical solution, the graph signal can be the soil moisture (available at some nodes), while the edge weights can be a function of temperature and vegetation information. In some examples, this technical solution can, to refine the coarse resolution signal, solve the following optimization problem:

$$\hat{x} = {min}_{x} α {\underbrace{{‖ y - x ‖}_{Q}^{2}}}_{Data} + λ {\underbrace{{‖ x - ( az - b ) ‖}_{2}^{2}}}_{Model} + μ {\underbrace{{x}^{T} Lx}}_{Graph} . \qquad ( 1 )$$

The data component prioritizes soil moisture observations that share a similar elevation. In one or more examples, this technical solution can include a model component to reconstruct one or more correlations between soil moisture and vegetation attributes, including vegetation optical depth and water content. Lastly, in this example, the graph component can impose a smoothness constraint on the prediction output by the system 200. Consequently, in this example of the technical solution, the optimization function considers soil moisture properties and how they relate to various ancillary datasets and terrain information.

One or more examples can include a data fitting term

$$α {‖ y - x ‖}_{Q}^{2}$$

that can quantity the difference between the interpolated (enhanced) signal x and a baseline interpolated signal at the same target resolution, y, which can be obtained via conventional kriging. For example this technical solution can compare these signals (described above) using a weighted norm:

$${‖ y - x ‖}_{Q}^{2} = {‖ {Q}^{0.5} ( y - x ) ‖}_{2} , \qquad ( 2 )$$

$$where Q = diag ( q ) with {q}_{k}^{- 1} = 1 + {( \frac{{slope}_{k}}{ϵ} )}^{p} .$$

For example, the function relating the weights q and the slope can be monotonically decreasing and the parameter e can controls a point where the function begins an increased attenuation, and p can control the flatness of the curve before the point c. In this example of the present technical solution, p=6 and ϵ=2·std (slope) can be chosen to have similarly large weights for low slopes. The value for each of the parameters can be determined so that the conventional spatial interpolation y can be more reliable in flat regions and less reliable in inclined areas, where soil moisture can be more likely to change (e.g., between two adjacent nodes).

Some examples can include the model term

$$λ {‖ x - ( az - b 1 ) ‖}_{2}^{2}$$

that can use ancillary data z at the higher (enhanced) resolution. In this technical solution, the vegetation water content of each node can be determined with, and/or chosen as, ancillary data. In some examples, that model term can be indicative of a linear structural equation model created for the missing data. For example, this technical solution may be configured to assume this model, and/or the target variable, can be predicted from the ancillary variable using a linear model. In some examples, the model parameters can be learned for nodes where the target variable may be known and applied to nodes where the target variable may be unavailable and may be interpolated. One or more examples can include this model, which can be configured to generate estimates of the absent signals based on the graph structure rather than its smoothness. For example, this technical solution can include the graph signal configured as a linear combination of high-resolution elements that may be used to assist in quantifying certain properties of the signal.

For example, this technical solution can include a graph term μx^{T}Lx that can be used to generate a smooth signal reconstruction, where the smoothness depends on the edge weights of the chosen graph. In one or more examples, and during optimization, a graph Laplacian can be selected from the three described options below, which may enhance the adaptability of this technical solution to diverse scenarios. For example, the first graph Laplacian, L1, can correspond to a graph with edge weights based on the Gaussian kernel to the Euclidean distance between the LST values tᵢ and tⱼ on pixels i and j, respectively:

$${L}_{1} : {w}_{ij} = exp ( - \frac{{‖ {t}_{i} - {t}_{j} ‖}_{2}^{2}}{{σ}_{lst}^{2}} ) , \qquad ( 3 )$$

where σₗₛₜ can be a tuning parameter that may be used to control the bandwidth of the Gaussian curve. In some examples, L1 may be chosen based on an assumption that temperature differences and soil moisture differences will be correlated. Thus, in one or more examples of the technical solution the interpolated SM signal x can be required to be more locally smooth if the corresponding temperatures can be similar in that region. For example, the second graph Laplacian, L2, can use the cross-correlation R between two vectors of local LST values and uᵢ and uⱼ may be the vectorizations of Uᵢ and Uⱼ, and the K×K areas of LST values may be centered on pixels i and j, respectively. In one or more examples described herein, L2 can be defined as:

$${L}_{2} : {w}_{i , j} = Re LU ( R ( {u}_{i} , {u}_{j} ) ) . \qquad ( 4 )$$

And, in those examples, a correlation operation (e.g., ReLU function) can force substantially all negative correlation coefficients to approach zero so that two pixels can be disconnected in the Laplacian graph if not positively correlated. For example, as an alternative to consider differences in spatial distribution within each region, one or more examples can include a third graph Laplacian:

$${L}_{3} : {w}_{i , j} = SSIM ( {U}_{i} , {U}_{j} ) , \qquad ( 5 )$$

Which can use the structural similarity index measure (SSIM) to include the distribution of LST values as part of the similarity. Specifically, in one or more examples, and fo a given cross-correlation R(uᵢ, uⱼ), the SSIM-based weights in L3 may be larger if the two regions may be smooth and smaller if the regions (with the same cross-correlation) have more local variability. This information can be valuable because when there is higher variability in LST (lower SSIM), it can signify one or more fluctuations in local temperature patterns. Consequently, for some examples, and during interpolation tasks, the reliance on neighboring regions need not be significantly emphasized.

This technical solution can generate an example of interpolation results using the corresponding method(s) described herein, which may be compared with the results generated with the existing kriging interpolation. In some examples, one or more of the parameters in (1) can be chosen so that α=0.45, λ=0.2, and μ=1. In this example, each of the coefficients for the model term can be learned to be a=0.0225, and b=0.1459 and the parameter σ_{LST} for defining L1 can be chosen as the standard deviation of LST values for each month. Additionally, the window size of areas Ui and Uj, which can be used in defining L2 and L3, can be set to K=5. This technical solution can include a user interface (e.g., display 130) used to present a view with quantitative indicators, which may represent the observed soil moisture (SM) values and that may be confirmed with one or more in-situ measurements (e.g., using in-situ soil moisture measurements on a 36 km grid at the Tonzi Ranch validation site). In some examples, a kriging interpolation result can also be the signal y used in (1) as an interpolation reference. As described above, Kriging may use only the distance between known and unknown data points, and it may neglect other influential factors. For example, one or more views of the average Land Surface Temperature (LST) can be obtained from a more precise 9 km grid during the same month and in the same location. In one or more examples, a satellite-based image can uncover a spatial structure within the LST data, displaying similar LST values along the ridges.

For example, this technical solution can generate an enhanced image map, which may be compared, in some examples, with one or more available in-situ measurements. For example, an accuracy can be determined for the enhanced sensor data provided by this technical solution, which can include calculating the Pearson correlation (R) between the soil moisture estimates generated by this technical solution, and actual in-situ sensor measurements. In some examples, an evaluation of the enhanced sensor data accuracy can be extended to include comparisons with conventional interpolation techniques including, but not limited to, kriging and the nearest neighbor approach. And some examples including a comparison of a mean absolute error (MAE) between the prediction (e.g., enhanced sensor data) and one or more in-situ measurements. The results of such comparisons can demonstrates a superior error performance of the enhanced sensor data (e.g., the output of this technical solution) compared to existing methods of interpolation.

The technical solution disclosed herein can enhance the resolution of one or more remotely sensed images, which reflects the corresponding methodology for integrating ancillary variables, including, but not limited to, terrain data and/or vegetation features. Accordingly, an interpolation generated by this technical solution need not be solely based on one or more assumptions regarding the spatial smoothness of sensor datasets. The methodology disclosed herein can represents a technical solution that can more accurately enhance the resolution of one or more remote different (multimodal) sensing datasets, which can include merging multiple modalities within a graph structure. For example, the examples disclosed herein can increase a resolution for a remote sensing dataset with values of the physical property of interest that take into account one or more correlations within and between corresponding nodes of the remote sensing data (e.g., remote sensing data modalities).

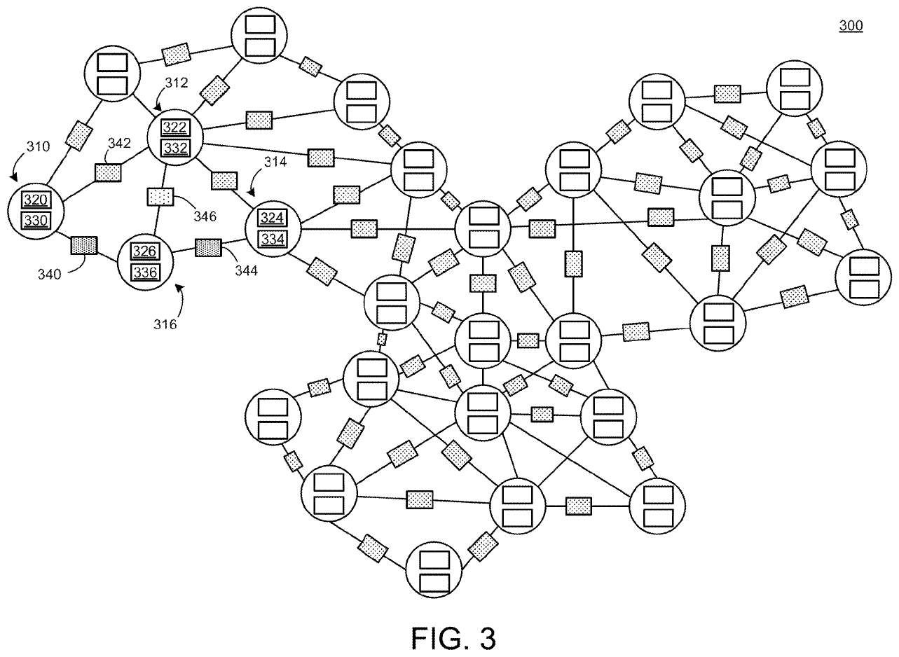

FIG. 3 depicts an example graph enhancement network architecture according to this disclosure. As illustrated by way of example in FIG. 3, a graph enhancement network architecture 300 can include at least a first network node 310, a second network node 312, a third network node 314, and a fourth network node 316.

The first network node 310 can include a first reliability value 320, a first predictability value 330, and a first similarity value 340. The first reliability value 320 can include a respective first quantitative value of a first physical property at a first location in the corresponding geographical region 102. For example, the first reliability value 320 can include a quantitative value indicative of a soil moisture at a first location (e.g., at a first granularity and/or a coarse resolution) in the geographical region 102. More specifically, the first reliability value can represent the quantitative value for the soil moisture at the first location and collected by one or more of a plurality of in-situ sensors and/or a remote sensor system (e.g., one or more satellite-based sensor systems 106A-C). In other examples, the first reliability value 320 can reflect an enhanced estimate of the quantitative value for the soil moisture at the second location, the enhanced estimate generated according the predictability values (e.g., values 330-336) and the corresponding similarity values between the corresponding one or more network nodes (e.g., similarity values 340-346) of the graph network 300.

The first predictability value 330 can represent a correlation between the first physical property of the first node metrics and the second physical property of the second node metrics, which can be determined, in some examples, according to a linear model and may determine the correlation without first considering a corresponding spatial similarity. For example, the first predictability value 330 can include a correlation between one or one or more of an altitude and/or a topographic slope gradient and a soil moisture, which may be determined using a linear model applied to each of physical property and before considering the corresponding spatial similarity at the second location (e.g., at a second granularity greater than the first granularity of the first reliability value 320 and/or having a fine spatial resolution) in the geographical region 102.

The first similarity value 340 can include a connection metric between the first network node 310 and a fourth network node 316, which is indicative of the second physical property between the first network node 310 and the fourth network node 316. For example, the first similarity value 340 can include a connection metric of the first and fourth network nodes 310, 340, which can indicate a degree of similarity in one or more of an evapotranspiration property, vegetation water content, and/or a land surface temperature between the first and fourth network nodes 310, 316. For example, the similarity value 340 can include a connection metric indicative of substantially similar evapotranspiration properties between the first and fourth network nodes 310, 316 and that can be reflected in the corresponding weight of the first similarity value 340. More specifically, a similarity value that reflects a high degree of similarity between two network nodes will include a weight that is closer to 1.0. In contrast, a similarity value indicative of a highly dissimilar third physical property between two network nodes (e.g., indicating the second physical property that differs between the two corresponding nodes), the weight for that similarity value is closer to zero.

The second network node 312 can include a second reliability value 322, a second predictability value 332, and a second similarity value 342. The second reliability value 322 can include a respective quantitative value of a first physical property at a first location in the corresponding geographical region 102. For example, the second reliability value 322 can include a second quantitative value indicative of a soil moisture at a corresponding location (e.g., at a first granularity and/or a coarse resolution) in the geographical region 102. More specifically, the second reliability value 322 can represent the quantitative value for the soil moisture at the first granularity and can be collected by one or more coarse sensors (e.g., one or more coarse local sensors), including one or more in-situ sensors or coarse data of a remote sensor (e.g., a coarse dataset collected by the first satellite-based sensor system 106A). In other examples, the second reliability value 322 can reflect an enhanced estimate for a quantitative value of the first physical property (e.g., soil moisture) at the second location. For example, an enhanced estimate can be generated for the second reliability value 322 according to the values of each of the other network nodes included in the graph network 300, including each of the corresponding predictability values (e.g., values 330-336) and each of the similarity values between corresponding nodes of the graph network 300 (e.g., each of the similarity values 340-346).

The second predictability value 332 can capture a correlation determined for the first and second physical properties of the first and second node metrics, which can be determined, in some examples, according to a linear model applied to the first and second physical properties and that can be used to determine the correlation without first considering the spatial similarity of the first and/or second node metrics. For example, the second predictability value 332 can include a correlation between one or one or more of an altitude and/or a topographic slope gradient and a soil moisture, which may be determined using a linear model applied to each of physical property and determined before considering the spatial similarity at the second location of the geographical region 102.

The second similarity value 342 can include a connection metric between the first network node 310 and the second network node 312, which is indicative of the third physical property between the first network node 310 and the second network node 312. For example, the second similarity value 342 can include a connection metric indicative of the third physical property that is moderately similar between the first and second network nodes 310, 320. In some examples, the second connection metric 342 can indicate one or more of a moderately similar evapotranspiration property (e.g., vegetation water content) and/or a moderately similar land surface temperature between the first and second nodes 310, 312. For example, the second similarity value 342 can include a connection metric indicative of moderately similar evapotranspiration properties between the first and second network nodes 310, 312, which can be represented in the weight of the second similarity value 342. More specifically, a similarity value that reflects only moderate similarity between two nodes can be represented by a weight of the similarity value that is close to 0.50 (e.g., a linear middle point between the minimum and the maximum for the similarity value and/or edge weight). In other examples, however, a similarity value can represent the degree of similarity between corresponding nodes according to a non-linear weighting. For example, the second similarity value 332 can represent a moderate degree of similarity between the third physical property of the first and second nodes 310, 312 and it may include a weight, or magnitude, that closer to 1.0 than 0.50 (e.g., as a logarithmic function of the differences between the first and second nodes 310, 312).

The third network node 314 can include a third reliability value 324, a third predictability value 334, and a third similarity value 344. The third reliability value 324 can include a respective quantitative value for the first physical property and at a corresponding location (e.g., a first subregion) in the corresponding geographical region 102. For example, third reliability value 324 can include a third quantitative value indicative of a soil moisture at a corresponding location (e.g., at a first location and a first granularity and/or according to a coarse resolution) in the geographical region 102. More specifically, the third reliability value 324 can represent the quantitative value for the soil moisture at the second granularity and can reflect data estimated based on different, heterogenous, datasets collected from one or more remote sensors (e.g., one or more datasets collected at, and transmitted by, one or more of the satellite-based sensor systems 106A-C). Accordingly, in some examples, the third reliability value 324 can reflect an enhanced estimate of the quantitative value of the first physical property (e.g., soil moisture) at the corresponding location for the third network node 314 (e.g., at the second location). For example, an enhanced estimate of the third reliability value 324 can be generated according to each of the other network nodes in the graph network 300. For example, the enhanced estimate for the third reliability value 324 can be generated according to at least each of the predictability values (e.g., predictability values 330, 332, and 336) and the similarity values between each of the one or more corresponding nodes in graph network 300 (e.g., each of the similarity values 340, 342, 344, and 346).

The third predictability value 334 can capture or reflect a correlation between the first and second physical properties, which correlation can be determined using a linear model applied to the first and second physical properties at each of the first and second notes to determine the correlation, or third predictability value 334 without regard to the spatial similarity between corresponding first and/or second nodes. For example, the third predictability value 334 can reflect the correlation between one or one or more of an altitude and/or a topographic slope gradient and the a soil moisture at the location of the third node 314 and determined according to a linear model and without considering the corresponding spatial similarity for the third node 314.

The third similarity value 344 can include a connection metric between the third network node 314 and the fourth network node 316, which is indicative of the third physical property between the third and fourth network nodes 314, 316. For example, the third similarity value 344 can include a connection metric indicative of the third physical property that is substantially similar between the third and fourth network nodes 314, 316. In some examples, the third similarity value 344 can indicate one or more of an evapotranspiration property (e.g., vegetation water content) and/or land surface temperature that is substantially similar between the third and fourth network nodes 314, 316. For example, the third similarity value 344 can include a connection metric indicative of moderately similar evapotranspiration properties between the third and fourth network nodes 314, 316, which can be represented in the corresponding weight (e.g., magnitude) of the third similarity value 344. In some examples, a similarity value that reflects substantial similarity (e.g., in the third physical property) between two nodes can be represented according to a non-linear function that attenuates similarity values greater than 0.50 (e.g., reducing similarity values greater than 0.50 according to a nonlinear and/or logarithmic operation).

The fourth network node 316 can include a fourth reliability value 326, a fourth predictability value 336, and a fourth similarity value 346. The fourth reliability value 326 can include a respective quantitative value for the first physical property and at a corresponding location (e.g., a first subregion) in the corresponding geographical region 102. For example, fourth reliability value 326 can include a fourth quantitative value indicative of a soil moisture at a corresponding location (e.g., at a first location and a first granularity and/or according to a coarse resolution) in the geographical region 102. More specifically, the fourth reliability value 326 can represent the quantitative value for the soil moisture at the second granularity and can reflect data estimated based on different, heterogenous, datasets collected from one or more remote sensors (e.g., one or more datasets collected at, and transmitted by, one or more of the satellite-based sensor systems 106A-C). Accordingly, in some examples, the fourth reliability value 326 can reflect an enhanced estimate of the quantitative value of the first physical property (e.g., soil moisture) at the corresponding location for the fourth network node 316 (e.g., at the second location). For example, an enhanced estimate of the fourth reliability value 326 can be generated according to each of the other network nodes in the graph network 300. For example, the enhanced estimate for the fourth reliability value 326 can be generated according to at least each of the predictability values (e.g., predictability values 330, 332, and 336) and the similarity values between each of the one or more corresponding nodes in graph network 300 (e.g., each of the similarity values 340, 342, 344, and 346).

The fourth predictability value 336 can represent a correlation between the first and second physical properties and determined according to a linear model of the values of the first and second physical properties indicated by each of the first or second nodes and determine the fourth predictability value 336 without first considering, or without regard to, the spatial similarity between one or more first and/or second nodes. For example, the fourth predictability value 336 can reflect the correlation between one or one or more of an altitude and/or a topographic slope gradient and the a soil moisture at the location of the fourth node 316, which can be determined according to a linear model and without first considering the spatial similarity corresponding to the fourth node 316.

The fourth similarity value 346 can include a connection metric between the fourth network node 316 and the second network node 312, which is indicative of the third physical property between the fourth and second network nodes 316, 312. For example, the fourth similarity value 346 can include a connection metric indicative of the fourth physical property that is substantially similar between the fourth and second network nodes 316, 312. In some examples, the fourth similarity value 326 can indicate one or more of an evapotranspiration property (e.g., vegetation water content) and/or land surface temperature that is substantially similar between the fourth and second network nodes 316, 312. For example, the fourth similarity value 346 can include a connection metric indicative of moderately similar evapotranspiration properties between the fourth and second network nodes 316, 312, which can be represented in the corresponding weight (e.g., magnitude) of the fourth similarity value 346. In some examples, a similarity value that reflects substantial similarity (e.g., in the third physical property) between two nodes can be represented according to a non-linear function that attenuates similarity values greater than 0.50 (e.g., reducing similarity values greater than 0.50 according to a nonlinear and/or logarithmic operation).

FIG. 4 depicts an example coarse graph network architecture according to this disclosure. As illustrated by way of example in FIG. 4, the coarse graph network architecture 400 corresponds to a graph network at a first granularity for a corresponding geographic region 402. The graph network 400 can include at least a first remote sensor node 410, a second remote sensor node 420, a third remote sensor node 430, and a fourth remote sensor node 440. In some examples, each remote sensor node (e.g., each of the remote sensor nodes 410-440) indicates a respective first physical property at the first location of the geographic region 402. For example, the coarse graph network 400 can depict an example model (e.g., a first model) output by the coarse model engine 220 (depicted in FIG. 2) according to a coarse dataset of the first physical property at a first granularity (e.g., using a coarse spatio-temporal resolution).

The first remote sensor node 410 can indicate the first physical property at the corresponding location within the geographic region 402. The first remote sensor node 410 can include or indicate a first remote sensor value 412 of the first physical property at the location of the first remote sensor node 410 (e.g., at a north-east subregion of the geographic region 402). The first remote sensor value 412 can indicate the lowest value for the first physical property relative to the other remote sensor nodes of graph network 400. For example, the first remote sensor value 412 can indicate a value of the first physical property equal to approximately 0.25. In some examples, the first remote sensor value 412 can indicate a soil moisture (e.g., a water fraction by volume) of 0.25 percent at the location of the first remote sensor 410.

The second remote sensor node 420 can indicate a value of the first physical property at the corresponding location in the geographic region 402. The second remote sensor node 420 can include a second remote sensor value 422 of the first physical property at the location of the second remote sensor node 420 (e.g., at the south-west subregion of the geographic region 402). The second remote sensor node 420 can include a second remote sensor value 422. The second remote sensor value 422 can indicate a moderate value (e.g., approximately middle of the scale provided for the remote sensor measurements 412, 422, 432, and 442) for the first physical property. For example, the second remote sensor value 422 can indicate a value of the first physical property equal to approximately 0.55. In some examples, the second remote sensor value 422 can indicate a soil moisture (e.g., a water fraction by volume) of 0.55 percent at the south-west subregion (e.g., the location of the second remote sensor 420).

The third remote sensor node 430 can indicate a third value of the first physical property at the corresponding location in the geographic region 402. The third remote sensor node 430 can include a third remote sensor value 432 of the first physical property at the location of the third remote sensor node 430 (e.g., the north-west subregion in the geographic region 402). The third remote sensor value 432 can indicate a second greatest value of the first physical property relative to the other remote sensor values of the graph network 400 depicted in FIG. 4. For example, the third remote sensor value 432 can indicate a third value of the first physical property equal to approximately 0.68. In some examples, the third remote sensor value 432 can indicate a soil moisture (e.g., a water fraction by volume) of 0.68 percent in the subregion of the third remote sensor node 430.

The fourth remote sensor node 440 can indicate a fourth value of the first physical property at the corresponding location in the geographic region 402. The fourth remote sensor node 440 can include a fourth remote sensor value 442 of the first physical property at the location of the fourth remote sensor node 440 (e.g., the north-central subregion of geographic region 402). The fourth remote sensor value 442 depicted in FIG. 4 represents the greatest value of the first physical property relative to the other remote sensor values of the graph network 400 depicted in FIG. 4. For example, the fourth remote sensor value 442 can indicate a fourth value of the first physical property of approximately 0.68. In some examples, the fourth remote sensor value 442 can indicate a 0.68 percent soil moisture value (e.g., water fraction by volume) in the subregion of the fourth remote sensor node 440.

FIG. 5A depicts an example fine graph network architecture according to this disclosure. As illustrated by way of example in FIG. 5A, a fine graph network architecture 500A can include at least a node 510A, and an edge 520A. The fine graph network architecture 500A depicts an example of a second model (e.g., a model generated by, and/or output from, the fine model engine 230 depicted in FIG. 2), including a plurality of nodes 510A at a fine granularity and in a corresponding geographic region 502.

Each of the nodes 510A can indicate, respectively, a second physical property at a second location (e.g., collectively, at a second granularity) in the geographic region 502 of the fine graph network 500A. For example, the fine graph network 500A depicts an example of a model output by the fine model engine 230 (depicted in FIG. 2) using one or more remote sensor datasets indicative of a second physical property at a second granularity in the geographic region 502 (e.g., at a second granularity, greater than a first granularity of the coarse graph network 400 shown in FIG. 4). The fine graph network 500 can include a plurality of edges, including edge 520A for node 510A. In some examples, the edges (e.g., edge 520A) indicate the second physical property between the corresponding nodes, which is used to determine the weight of each edge. Accordingly, the edges of graph network 500A (e.g., edge 520A) can each include and/or indicate an edge value and/or an edge weight (e.g., as output by the graph edge processor 234 depicted in, and described with reference to, FIG. 2). As described above, the weight of the edge 520A can indicate a weight used to compute a weighted aggregate of the nodes in fine graph network 500A, including for the nodes corresponding to (e.g., connected by) the edge 520A.

FIG. 5B depicts an example enhanced fine graph network architecture according to this disclosure. In some examples, including as depicted in FIG. 5B, the fine graph network 500B can reflect a plurality of enhanced nodes, each respectively indicative of a soil moisture percentage (e.g., the first physical property) at the geographic region 502. As illustrated by way of example in FIG. 5B, an enhanced fine graph network architecture 500B can include at least a first enhanced node 510B, a second enhanced node 512B, a third enhanced node 514B, a fourth enhanced node 516B, a fifth enhanced node 518B, a first enhanced edge 520B, a second enhanced edge 522B, a third enhanced edge 524B, and a fourth enhanced edge 526B.

The first enhanced node 510B can indicate one or more of a first physical property and/or a second physical property at the second location (e.g., corresponding to first node 510B) in the geographic region 502. The first enhanced node 510B can include a first enhanced sensor value of the first physical property at the location of the first enhanced node 510B (e.g., at a north-east corner of the geographic region 502). The first enhanced node 510B can indicate, as depicted in FIG. 5B, a first enhanced sensor value that reflects the lowest value of the first physical property relative to the values of the first physical property indicated by the other enhanced sensor nodes of enhanced fine graph 500B. For example, the first enhanced sensor value of the first enhanced node 510B can indicate a value of the first physical property equal to approximately 0.05 (e.g., less than 0.1). More specifically, in some examples, the sensor value of the first enhanced node 510B can indicate a soil moisture percentage (e.g., a water fraction by volume) of less than 0.10 percent at the north-east corner location in the geographic region 502 that corresponds to the enhanced fine graph network 500B.

The second enhanced node 512B can indicate one or more of a first physical property and/or a second physical property at the second location (e.g., corresponding to second node 512B) in the geographic region 502 that corresponds to the enhanced fine graph network 500B The second enhanced node 512B can include (e.g., or indicate) a second enhanced sensor value (e.g., a second enhanced node metric) of the first physical property at the location of the second enhanced node 512B (e.g., at a north east-of-center subregion in the geographic region 502). The second enhanced node 512B can indicate, as depicted in FIG. 5B, a second enhanced sensor value that reflects a second lowest value of the first physical property relative to the values of the first physical property indicated in the nodes of graph network 500B. For example, the second enhanced sensor value of the second enhanced node 512B, as depicted in FIG. 5B, indicates a value of the first physical property equal to approximately 0.30. More specifically, in some examples, the second enhanced node 512B can indicate a value of the soil moisture percentage (e.g., a water fraction by volume) equal to approximately 0.30 percent.

The third enhanced node 514B can indicate one or more of a first physical property and/or a second physical property at the second location (e.g., corresponding to the third enhanced node 514B) in the geographic region 502 corresponding to the fine graph network 500B The third enhanced node 514B can include (e.g., or indicate) a third enhanced sensor value (e.g., a third enhanced node metric) of the first physical property at the location of the third enhanced node 514B (e.g., at a third subregion located at the southern center portion of the geographic region 502). The third enhanced node 514B can indicate, as depicted in FIG. 5B, a third enhanced sensor value for a moderate (e.g., mean) value of the first physical property relative to the values of the first physical property indicated by the plurality of enhanced nodes of the graph network 500B. For example, the value of the third enhanced node 514B, as it is depicted in the example of FIG. 5B, indicates a value of the first physical property equal to approximately 0.50. More specifically, in the example depicted in FIG. 5B, the third enhanced node 514B can indicate a soil moisture percentage (e.g., a water fraction by volume) equal to approximately 0.50 percent.

The fourth enhanced node 516B can indicate one or more of a first physical property and/or a second physical property at the second location (e.g., corresponding to the fourth enhanced node 516B) in the geographic region 502 corresponding to the fine graph network 500B The fourth enhanced node 516B can include (e.g., or indicate) a fourth enhanced sensor value (e.g., a fourth enhanced node metric) of the first physical property at the location of the fourth enhanced node 516B (e.g., at a fourth subregion located near the north-western corner of the geographic region 502). The fourth enhanced node 516B can indicate, as depicted in FIG. 5B, a fourth enhanced sensor value that is the second largest value of the first physical property relative to each of the other enhanced nodes in the graph network 500B. For example, the value of the fourth enhanced node 516B, in the example depicted in FIG. 5B, reflects a value of the first physical property equal to approximately 0.70. More specifically, the example depicted in FIG. 5B reflects the fourth enhanced node 516B indicative of a second greatest soil moisture percentage (e.g., a water fraction by volume), which is equal to approximately 0.70 percent.

The fifth enhanced node 518B can indicate one or more of a first physical property and/or a second physical property at the second location (e.g., corresponding to the fifth enhanced node 518B) in the geographic region 502 corresponding to the fine graph network 500B The fifth enhanced node 518B can include (e.g., or indicate) a fifth enhanced sensor value (e.g., a fifth enhanced node metric) of the first physical property at the location of the fifth enhanced node 518B (e.g., at a fifth subregion located at the northmost center subregion of the geographic region 502). The fifth enhanced node 518B can indicate, as depicted in FIG. 5B, a fifth enhanced sensor value that is the second largest value of the first physical property relative to each of the other enhanced nodes in the graph network 500B. For example, the value of the fifth enhanced node 518B, in the example depicted in FIG. 5B, reflects a value of the first physical property equal to approximately 0.70. More specifically, the example depicted in FIG. 5B reflects the fifth enhanced node 518B indicative of a second greatest soil moisture percentage (e.g., a water fraction by volume), which is equal to approximately 0.70 percent.

The first enhanced edge 520B can reflect an example of a first edge weight assigned to one or more of the graph edges (e.g., connection metrics) included in the graph network 500B. The first enhanced edge 520B can include a first edge weight 530B, which reflects the weighted value assigned to the first enhanced edge 520B. In the example depicted in FIG. 5B, the first edge weight 530B represents a value of approximately 0.075, which reflects the weight for the first enhanced edge 520B and which represents the lowest weight associated with any of the or more of the enhanced edges included in graph network 500B. For example, the relatively low value of enhanced edge weight 530B can represent a corresponding dissimilarity of the third physical property between the two enhanced nodes of the enhanced edge 520B.

The second enhanced edge 522B can represent a second weight assigned to one or more of the graph edges (e.g., connection metrics) included in graph network 500B. The second enhanced edge 522B can include a second edge weight 532B, which reflects a second weight (e.g., a second connection metric) assigned to one or more enhanced edges, including at least the second enhanced edge 522B. In the example depicted in FIG. 5B, the second edge weight 532B includes a value of 0.15, which reflects an approximate mean of the weight values for all the enhanced edges in the graph network 500B. As described above, the relatively moderate weight of the second enhanced edge 522B can represent the corresponding degree of similarity between the two enhanced nodes corresponding to the second enhanced edge 522B (e.g., sharing moderately similar values for the third physical property).

The third enhanced edge 524B can represent a third weight assigned to one or more of the graph edges (e.g., connection metrics) included in graph network 500B. The third enhanced edge 524B can include a third edge weight 534B, which reflects a third weight (e.g., a third connection metric) assigned to one or more enhanced edges, including at least the third enhanced edge 524B. In the example depicted in FIG. 5B, the third edge weight 534B is approximately 0.225, which is a second largest weight of the enhanced edges in the graph network 500B. As described above, the relatively large third edge weight 524B can represent a corresponding (e.g., proportionate) amount of similarity of the nodes corresponding to the third enhanced edge 524B (e.g., highly similar with regard to the third physical property).

The fourth enhanced edge 526B can include a fourth edge weight 536B, which reflects a fourth value and the weight for one or more enhanced edges (e.g., connection metrics), including at least the fourth enhanced edge 526B. The fourth enhanced edge 526B can include (e.g., indicate) the fourth edge weight 536B, which is the largest weight value assigned to one or more enhanced edges, including the fourth enhanced edge 526B. In the example depicted in FIG. 5B, the fourth edge weight 536B is approximately 0.28 or the largest weight among the one or more enhanced edges of the graph network 500B. As described above, the large value of the fourth edge weight 526B reflects the highly similar third physical property between the corresponding nodes of the fourth enhanced edge 526B. Accordingly, the value of the fourth edge weight 536B reflects (e.g., is proportionate to) the similar values of the third physical property that are associated with each of the nodes corresponding to the fourth enhanced edge 528B.

FIG. 6A depicts an example user interface 606A with coarse subregions according to this disclosure. As illustrated by way of example in FIG. 6A, a user interface 606A with coarse subregions 600A can be displayed via the client system 130 and it may include at least a first geographic subregion view presentation 610A. The user interface 606A with coarse subregions 600A can include corresponding quantitative indications of a first physical property (e.g., soil moisture) at a first location (e.g., one or more coarse subregions) of the geographic region 602. The user interface with coarse subregions 600A can be displayed using one or more display devices, including a graphical display in electrical communication with the system 100 and/or the image enhancement system 110. For example, the user interface with coarse subregions 600A can be presented on the display 132 (depicted in FIG. 1), a display device associated with the image enhancement system 110 (see FIG. 1) and/or the one or more display devices 1024a-n of the computing system diagram 1000 (See FIG. 10A).

The first geographic subregion view presentation 610A includes a portion of land within the geographic region that corresponds to at least one coarse subregion (e.g., one or more first node metrics), indicative of a first physical property at the geographic subregion view 610A. As depicted in FIG. 6A, the first geographic subregion view 610A includes an area equal to the spatial resolution of the coarse sensor data indicated by the user interface with coarse subregions 600A. More specifically, in some examples, the area of the first geographic subregion 610A corresponds to a single first node parameter at the first (e.g., coarse) granularity in the geographic region 602. For example, the first geographic subregion view presentation 610A can include a view of one or more subregions at the first granularity, including, at least, the first subregion 610A with corresponding quantitative indications of the first physical property at the first location (e.g., with a coarse resolution).

FIG. 6B depicts an example user interface with first enhanced subregions according to this disclosure. As illustrated by way of example in FIG. 6B, a user interface with first enhanced subregions 600B can include at least a first geographic subregion view presentation 610B, a second geographic subregion view presentation 620B, and a third geographic subregion view presentation 630B. For example, the user interface with first enhanced subregions 600B can be displayed on one or more graphical displays in electrical communication with the system 100 and/or the image enhancement system 110. For example, the user interface with enhanced subregions 600B can be presented on the client display 132 (depicted in FIG. 1) and/or the one or more display devices 1024a-n of the computing system diagram 1000 (depicted in FIG. 10A).

The first geographic subregion view presentation 610B can include a portion of land within the geographic region 602 with an area equal to approximately one sensor value (e.g., node metric) at an enhanced resolution (e.g., at the second granularity) and indicating a single value of the first physical property at the geographic subregion view 610B. As depicted in FIG. 6B, the first geographic subregion view 610B can includes an area equal to the spatial resolution of the fine-resolution graph and/or a single node corresponding to an interpolated sensor value at an enhanced resolution. For example, the area of the first geographic subregion 610B may correspond to a single graph node at the second (e.g., fine) granularity and in the geographic region 602. Additionally, in some examples, the first geographic subregion view presentation 610B can include a view of a single (e.g., first) subregion at the second granularity with corresponding quantitative indications of the first physical property at the first geographic subregion 610B (e.g., at the second location). As depicted in FIGS. 6A and 6B, the first geographic subregion 610B of the user interface with first enhanced subregions 600B can reflect a second, or enhanced, granularity that is greater than a first granularity for the geographic subregion 610A presented in the coarse user interface 606A. For example, the first geographic subregion view presentation 610B can corresponding to a visual indication (e.g. color, brightness, pattern, or any combination thereof) based on a topological model that includes both sensor data located in-situ and geospatial features observed remotely via satellite.

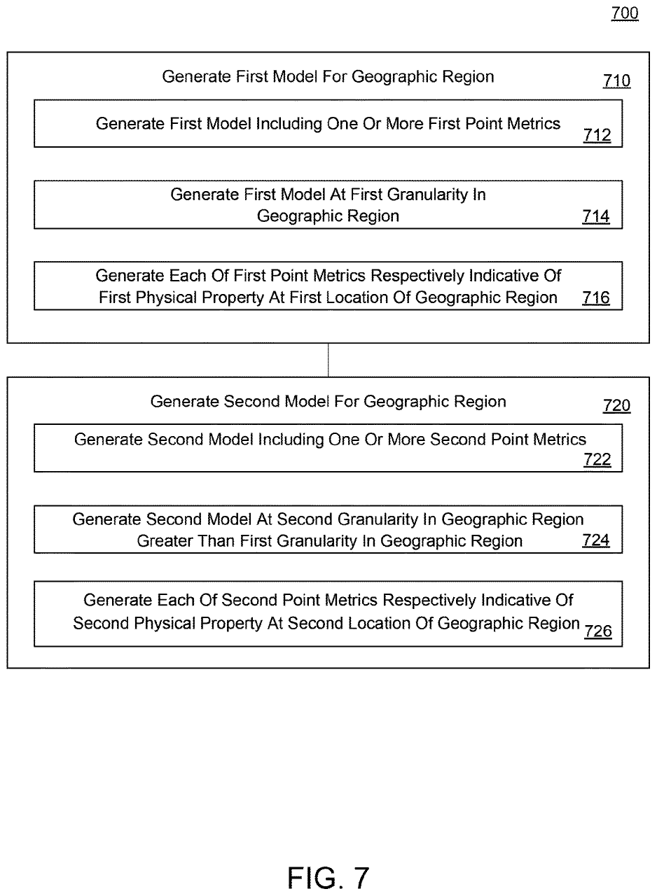

FIG. 7 depicts an example method of generating a plurality of models corresponding to a geographic region according to this disclosure. The method 700 can be performed by at least by the image enhancement system 110 depicted in FIG. 1, the computing device 1000 depicted in FIGS. 10A and 10B or, in some examples, the image enhancement engine architecture 200 depicted in FIG. 2 (e.g., as implemented by the image enhancement system 110 and/or the computing device 1000 depicted in FIGS. 10A and 10B) but is not limited thereto. Accordingly, one or more of the steps of the method 700 may be performed by a different processor, server, or any other computing device. For instance, one or more of the steps of the method 700 may be performed via a cloud-based service including any number of servers, which may be in communication with the remote sensor data system 120 depicted in FIG. 1, the image enhancement system 110, and/or the client system 130. Although the steps are shown in FIG. 7 having a particular order, it is intended that the steps of the method 700 may be performed in any order. It is also intended that some of these steps may be, in some examples, optional or omitted.

At 710, the method 700 can generate a first model for a geographic region. At 712, the method 700 can generate the first model including one or more first node metrics. For example, the method can include obtaining, via one or more sensors located at the geographic region, the first node metrics. At 714, the method 700 can generate the first model at a first granularity in the geographic region. For example, the method can include each of the one or more sensors (e.g., one or more sensors located at the geographic region, in-situ sensors 104, etc.) placed at the first location of the geographic region. At 716, the method 700 can generate each of the first node metrics respectively indicative of a first physical property at a first location of the geographic region. In some examples, the first physical property can correspond to an environmental condition at the geographical region. For example, the method can include a first physical property corresponding to at least one of an atmospheric property, a hydrological property, or a moisture property. Additionally, in some examples, the method can include the one or more first node metrics each corresponding to a respective quantitative value of the first property at the first location.

At 720, the method 700 can generate a second model for the geographic region. At 722, the method 700 can generate a second model including one or more second node metrics. For example, the method can include obtaining, via one or more sensors located remote from the geographic region, the second node metrics. For example, the method can include the one or more sensors located remote from the geographic region corresponding to one or more satellites each oriented toward the geographic region and configured to detect the second physical property.

At 724, the method 700 can generate a second model at a second granularity in the geographic region greater than the first granularity in the geographic region. At 726, the method 700 can generate each of the second node metrics respectively indicative of a second physical property at a second location of the geographic region. For example, the method can include a second physical property corresponding to at least one of a topological property, a geological property, or an altitude property. Additionally, in some examples, the method can include the one or more second node metrics each corresponding to a respective quantitative value of the second property at the second location.

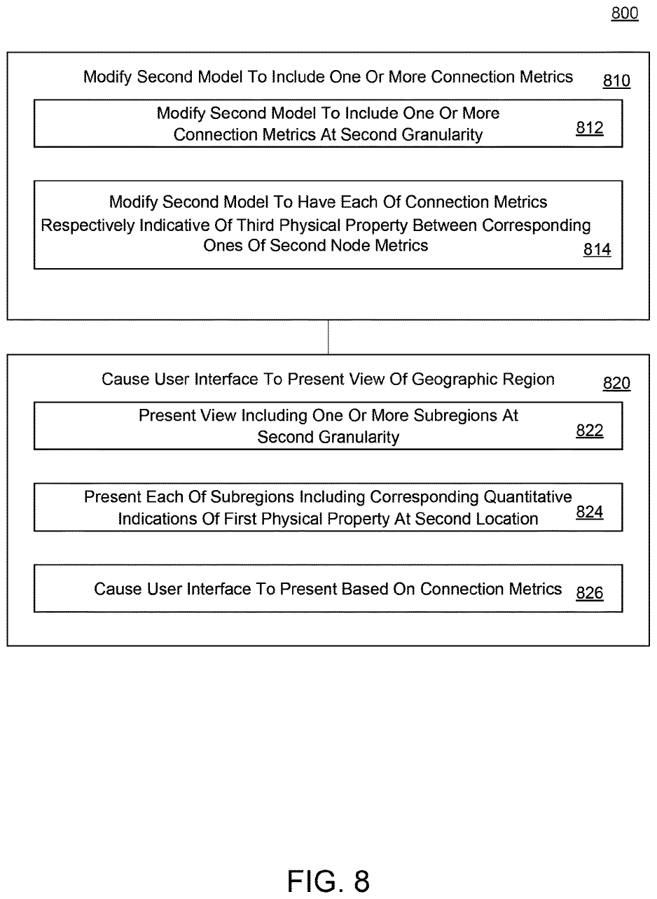

FIG. 8 depicts an example method of presenting one or more quantitative indications for a geographic region to a user according to this disclosure. The method 800 can be performed by at least by the image enhancement system 110 of the system 100 depicted in FIG. 1, the computing device 1000 depicted in FIGS. 10A and 10B or, in some examples, the image enhancement engine architecture 200 depicted in FIG. 2 (e.g., as implemented by the image enhancement system 110 and/or the computing device 1000 depicted in FIGS. 10A and 10B) but is not limited thereto. Accordingly, one or more of the steps of the method 800 may be performed by a different processor, server, or any other computing device. For instance, one or more of the steps of the method 800 may be performed via a cloud-based service including any number of servers, which may be in communication with the remote sensor data system 120 depicted in FIG. 1, the image enhancement system 110, and/or the client system 130. Although the steps are shown in FIG. 8 having a particular order, it is intended that the steps of the method 800 may be performed in any order. It is also intended that some of these steps may be, in some examples, optional or omitted.

At 810, the method 800 can modify the second model to include one or more connection metrics. At 812, the method 800 can modify the second model to include one or more connection metrics at the second granularity. At 814, the method 800 can modify the second model to have each of the connection metrics respectively indicative of the second physical property between corresponding ones of the second node metrics.

At 820, the method 800 can cause a user interface to present a view of the geographic region. At 822, the method 800 can present a view including one or more subregions at the second granularity. At 824, the method 800 can present each of the subregions including corresponding quantitative indications of the first physical property at the second location.

At 826, the method 800 can cause the user interface to present a view of the geographical region, including corresponding quantitative indications of the first physical property, based on the connection metrics. For example, the method can include generating, according to a weighted aggregation of a first output of a first transform operation among the plurality of transform operations and a second output of a second transform operation among the plurality of transform operations, the model metrics for each of the second locations.

In some examples, the method 800 can include causing the user interface (e.g., display 132) to present a view of the geographical region, including corresponding quantitative indications of the first physical property, using one or more transform operations. For example, the method can include a plurality of transform operations each corresponding to a respective interpolation operation from the first granularity (e.g., of the first model) to the second granularity. Accordingly, in some examples, the method 800 can include selecting an appropriate transform operation of the plurality of transform operations. For example, the method can include selecting from among the plurality of transform operations, a transform operation that satisfies a threshold indicative of an accuracy at the second granularity. Where, in some examples, the threshold (e.g., used to select a transform operation) is indicative of an accuracy of a transformation of the first node metrics at the first granularity to the second node metrics at the second granularity.

In some examples, the method 800 can include generating, according to a determination that the first transform operation does not satisfy the threshold indicative of the accuracy at the second granularity, the model metrics for each of the second locations according to the weighted aggregation (e.g., the weighted aggregation described above). For example, the method 800 can include generating, from the second node metrics according to one or more model metrics at the second granularity, one or more output node metrics corresponding to the quantitative indications, each of the model metrics indicative of a respective combination of a plurality of transform operations at the second location.

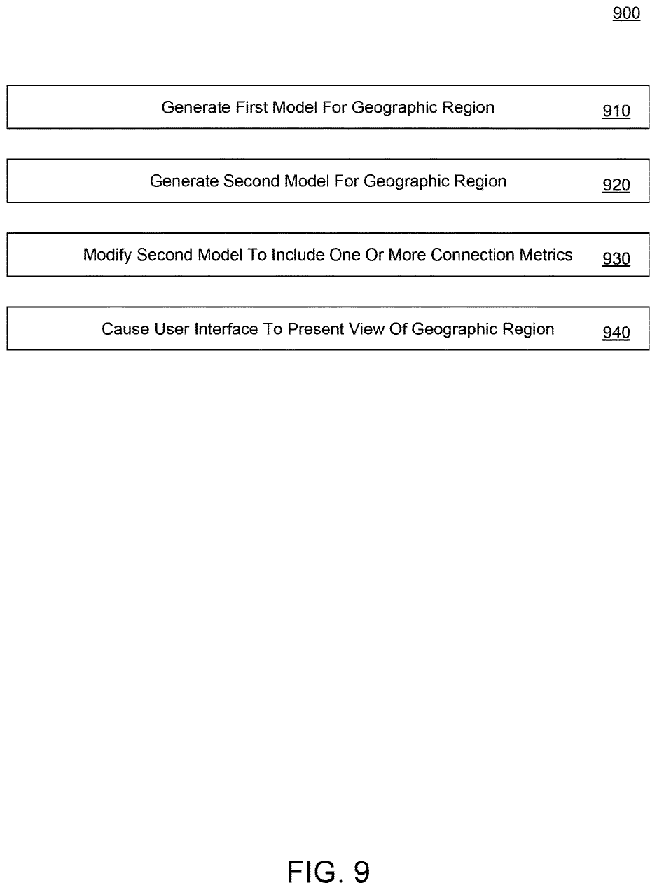

FIG. 9 depicts an example method of presenting a view of one or more quantitative indications for a geographic region according to this disclosure. The method 900 can be performed by at least the image enhancement system 110 of the system 100 depicted in FIG. 1, the computing device 1000 depicted in FIGS. 10A and 10B or, in some examples, the image enhancement engine architecture 200 depicted in FIG. 2 (e.g., as implemented by the image enhancement system 110 and/or the computing device 1000 depicted in FIGS. 10A and 10B) but is not limited thereto. Accordingly, one or more of the steps of the method 900 may be performed by a different processor, server, or any other computing device. For instance, one or more of the steps of the method 900 may be performed via a cloud-based service including any number of servers, which may be in communication with the remote sensor data system 120 depicted in FIG. 1, the image enhancement system 110, and/or the client system 130. Although the steps are shown in FIG. 9 having a particular order, it is intended that the steps of the method 900 may be performed in any order. It is also intended that some of these steps may be, in some examples, optional or omitted.

At 910, the method 900 can generate a first model for a geographic region. For example, the method 900 can include generating the first model for the geographic region as described above with reference to the coarse model engine 220 depicted in FIG. 2. At 920, the method 900 can generate a second model for the geographic region. For example, the method 900 can generate the second model for the geographic region according to substantially similar principles of operation described above with reference to the fine model engine 230 depicted in FIG. 2.

At 930, the method 900 can modify the second model to include one or more connection metrics. For example, the method 900 can modify the second model to include the one or more connection metrics described above with respect to the operation of the graph edge processor 236 and/or the edge weight processor 244, each depicted in FIG. 2.

At 940, the method 900 can cause a user interface to present a view of the geographic region. For example, the method 900 can cause a user interface to present (e.g., at the client display 132) a view of the geographic region, including quantitative indicators of the first physical property, including, but not limited to, the soil moisture or air quality, at a second (greater) granularity.

The device(s) or server(s) described herein may be deployed as and/or executed on any type and form of computing device, including, but not limited to, a computer, network device or appliance capable of communicating on any type and form of network and performing the operations described herein. FIGS. 10B and 10C depict block diagrams of a computing device 1000 useful for practicing an arrangement of the device(s) or server(s) described herein. As shown in FIGS. 10A and 10B, each computing device 1000 includes a central processing unit 1021, and a main memory unit 1022. As shown in FIG. 10A, a computing device 1000 may include a storage device 1028, an installation device 1016, a network interface 1018, an I/O controller 1023, display devices 1024a-1024n, a keyboard 1026 and a pointing device 1027, such as a mouse. The storage device 1028 may include, without limitation, an operating system and/or software. As shown in FIG. 10B, each computing device 1000 may also include additional optional elements, including, but not limited to, a memory port 1003, a bridge 1070, one or more input/output devices 1030a-1030n (generally referred to using reference numeral 1030), and a cache memory 1040 in communication with the central processing unit 1021.

The central processing unit 1021 is any logic circuitry that responds to and processes instructions fetched from the main memory unit 1022. In many arrangements, the central processing unit 1021 is provided by a microprocessor unit, such as: those manufactured by Intel Corporation of Mountain View, California; those manufactured by International Business Machines of White Plains, New York; or those manufactured by Advanced Micro Devices of Sunnyvale, California. The computing device 1000 may be based on any of these processors, or any other processor capable of operating as described herein.

Main memory unit 1022 may be one or more memory chips capable of storing data and allowing any storage location to be directly accessed by the microprocessor 1021, such as any type or variant of Static random access memory (SRAM), Dynamic random access memory (DRAM), Ferroelectric RAM (FRAM), NAND Flash, NOR Flash and Solid State Drives (SSD). The main memory 1022 may be based on any of the above described memory chips, or any other available memory chips capable of operating as described herein. In the arrangement shown in FIG. 10A, the processor 1021 communicates with main memory 1022 via a system bus 1050 (described in more detail below). FIG. 10B depicts an arrangement of a computing device 1000 in which the processor communicates directly with main memory 1022 via a memory port 1003. For example, in FIG. 10B the main memory 1022 may be DRDRAM.

FIG. 10B depicts an arrangement in which the main processor 1021 communicates directly with cache memory 1040 via a secondary bus, sometimes referred to as a backside bus. In other arrangements, the main processor 1021 communicates with cache memory 1040 using the system bus 1050. Cache memory 1040 typically has a faster response time than main memory 1022 and is provided by, for example, SRAM, BSRAM, or EDRAM. In the arrangement shown in FIG. 10B, the processor 1021 communicates with various I/O devices 1030 via a local system bus 1050. Various buses may be used to connect the central processing unit 1021 to any of the I/O devices 1030, for example, a VESA VL bus, an ISA bus, an EISA bus, a Microchannel Architecture (MCA) bus, a PCI bus, a PCI-X bus, a PCI-Express bus, or a NuBus. For arrangements in which the I/O device is a video display 1024, the processor 1021 may use an Advanced Graphics Port (AGP) to communicate with the display 1024. FIG. 10B depicts an arrangement of a computer 1000 in which the main processor 1021 may communicate directly with I/O device 1030b, for example via HYPERTRANSPORT, RAPIDIO, or INFINIBAND communications technology. FIG. 10B also depicts an arrangement in which local busses and direct communication are mixed: the processor 1021 communicates with I/O device 1030a using a local interconnect bus while communicating with I/O device 1030b directly.

A wide variety of I/O devices 1030a-1030n may be present in the computing device 1000. Input devices include keyboards, mice, trackpads, trackballs, microphones, dials, touch pads, touch screen, and drawing tablets. Output devices include video displays, speakers, inkjet printers, laser printers, projectors and dye-sublimation printers. The I/O devices may be controlled by an I/O controller 1023 as shown in FIG. 10A. The I/O controller may control one or more I/O devices such as a keyboard 1026 and a pointing device 1027, e.g., a mouse or optical pen. Furthermore, an I/O device may also provide storage and/or an installation medium 1016 for the computing device 1000. In still other arrangements, the computing device 1000 may provide USB connections (not shown) to receive handheld USB storage devices such as the USB Flash Drive.

Referring again to FIG. 10A, the computing device 1000 may support any suitable installation device 1016, such as a disk drive, a CD-ROM drive, a CD-R/RW drive, a DVD-ROM drive, a flash memory drive, tape drives of various formats, USB device, hard-drive, a network interface, or any other device suitable for installing software and programs. The computing device 1000 may further include a storage device, such as one or more hard disk drives or redundant arrays of independent disks, for storing an operating system and other related software, and for storing application software programs such as any program or software 1020 for implementing (e.g., configured and/or designed for) the systems and methods described herein. Optionally, any of the installation devices 1016 could also be used as the storage device. Additionally, the operating system and the software can be run from a bootable medium.

Furthermore, the computing device 1000 may include a network interface 1018 to interface to the network 1004 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, IEEE 802.11ac, IEEE 802.11ad, CDMA, GSM, WiMax and direct asynchronous connections). In one arrangement, the computing device 1000 communicates with other computing devices 1000′ via any type and/or form of gateway or tunneling protocol such as Secure Socket Layer (SSL) or Transport Layer Security (TLS). The network interface 1018 may include a built-in network adapter, network interface card, PCMCIA network card, card bus network adapter, wireless network adapter, USB network adapter, modem or any other device suitable for interfacing the computing device 1000 to any type of network capable of communication and performing the operations described herein.

In some arrangements, the computing device 1000 may include or be connected to one or more display devices 1024a-1024n. As such, any of the I/O devices 1030a-1030n and/or the I/O controller 1023 may include any type and/or form of suitable hardware, software, or combination of hardware and software to support, enable or provide for the connection and use of the display device(s) 1024a-1024n by the computing device 1000. For example, the computing device 1000 may include any type and/or form of video adapter, video card, driver, and/or library to interface, communicate, connect or otherwise use the display device(s) 1024a-1024n. In one arrangement, a video adapter may include multiple connectors to interface to the display device(s) 1024a-1024n. In other arrangements, the computing device 1000 may include multiple video adapters, with each video adapter connected to the display device(s) 1024a-1024n. In some arrangements, any portion of the operating system of the computing device 1000 may be configured for using multiple displays 1024a-1024n. One ordinarily skilled in the art will recognize and appreciate the various ways and arrangements that a computing device 1000 may be configured to have one or more display devices 1024a-1024n.

In further arrangements, an I/O device 1030 may be a bridge between the system bus 1050 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a FibreChannel bus, a Serial Attached small computer system interface bus, a USB connection, or a HDMI bus.

A computing device 1000 of the sort depicted in FIGS. 10A and 10B may operate under the control of an operating system, which control scheduling of tasks and access to system resources. The computing device 1000 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: Android, produced by Google Inc.; WINDOWS 7 and 8, produced by Microsoft Corporation of Redmond, Washington; MAC OS, produced by Apple Computer of Cupertino, California; WebOS, produced by Research In Motion (RIM); OS/2, produced by International Business Machines of Armonk, New York; and Linux, a freely-available operating system distributed by Caldera Corp. of Salt Lake City, Utah, or any type and/or form of a Unix operating system, among others.

The computer system 1000 can be any workstation, telephone, desktop computer, laptop or notebook computer, server, handheld computer, mobile telephone or other portable telecommunications device, media playing device, a gaming system, mobile computing device, or any other type and/or form of computing, telecommunications or media device that is capable of communication. The computer system 1000 has sufficient processor power and memory capacity to perform the operations described herein.

In some arrangements, the computing device 1000 may have different processors, operating systems, and input devices consistent with the device. For example, in one arrangement, the computing device 1000 is a smart phone, mobile device, tablet or personal digital assistant. In still other arrangements, the computing device 1000 is an Android-based mobile device, an iPhone smart phone manufactured by Apple Computer of Cupertino, California, or a Blackberry or WebOS-based handheld device or smart phone, such as the devices manufactured by Research In Motion Limited. Moreover, the computing device 1000 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

In some examples, one or more of the methods depicted in, and described with reference to, FIGS. 7-9 can be implemented by a computer readable medium, including one or more instructions stored thereon and executable by a processor (e.g., one or more of the image enhancement system 110, the computing device 1000 and/or the central processing unit 1021 included therein, etc.) to perform one or more of the methods 700, 800, 900 and/or or any portion thereof. For example, the computer readable medium can include one or more instructions executable by the processor to generate, from the second node metrics and according to one or more model metrics at the second granularity, one or more output node metrics. In some examples, the one or more output node metrics correspond to the quantitative indications, each of the model metrics indicative of a respective combination of a plurality of transform operations at the second location.

For example, the computer readable medium can include one or more instructions executable by a processor, including, for example, the central processing unit 1021 of the computing device 1000 depicted in FIGS. 10A and 10B to perform the functionalities described above with reference to methods 700, 800, and 900. In some examples, the computer readable medium can include one or more instructions executable by the processor to select from among a plurality of transform operations, a transform operation that satisfies a threshold indicative of an accuracy at the second granularity. Additionally, in some examples, the computer readable medium can further include the threshold indicating an accuracy of transformation of the first node metrics at the first granularity to the second node metrics at the second granularity.

In some examples, the computer readable medium can include one or more instructions executable by the processor to generate, according to a weighted aggregation of a first output of a first transform operation among the plurality of transform operations and a second output of a second transform operation among the plurality of transform operations, the model metrics for each of the second locations. As another example, the computer readable medium can include one or more instructions executable by the processor to generate, according to a determination that the first transform operation does not satisfy the threshold indicative of the accuracy at the second granularity, the model metrics for each of the second locations according to the weighted aggregation. And, in some examples, the computer readable medium can include a plurality of transform operations each corresponding to a respective interpolation operation from a first granularity to a second granularity.

For example, the computer readable medium can include one or more instructions executable by the processor to obtain, via one or more sensors located at the geographic region, the first node metrics. For example, the computer readable medium can include each of the one or more sensors placed at the first location of the geographic region. For example, the computer readable medium can include a first physical property corresponding to at least one of an atmospheric property, a hydrological property, or a moisture property. As another example, the computer readable medium can further include one or more first node metrics, each corresponding to a respective quantitative value of the first property at the first location.

Additionally, in some examples, the computer readable medium can include one or more instructions executable by the processor to obtain, via one or more sensors located remote from the geographic region, the second node metrics. For example, the computer readable medium can include the one or more sensors located remote from the geographic region corresponding to one or more satellites each oriented toward the geographic region and configured to detect the second physical property. Additionally, in some examples, the computer readable medium can include one or more second node metrics, each corresponding to a respective quantitative value of the second property at the second location. Moreover, in some examples, the computer readable medium can further include the second physical property corresponding to at least one of a topological property, a geological property, or an altitude property.

One or more limitations of conventional signal processing techniques can include one or more inherent irregularities that may be included in each dataset. For example, one or more inherent irregularities can be caused by physical terrain information or can be introduced by the measurement system. For example, radar imagery can include a target scene that may be heavily affected by aspect angles and/or a position of the instruments (e.g., the radar transmitter and/or receiver). Accordingly, one or more small variations in the aspect angles or positions of a radar imagery system can produce substantially different reflectivity patterns and, as a result, one or more non-uniform images. Similarly, if the original image has large missing regions (e.g., due to cloud cover) this can lead to distorted structures or blurry textures that may be inconsistent with surrounding areas.

Some arrangements disclosed herein relate to GSP interpolation methods that can combine data provided by two or more space-borne instruments, and in some examples with ancillary terrain information. Accordingly, a different higher-resolution dataset (e.g., a first dataset) is used to construct a graph on which a lower resolution target dataset (e.g., a second dataset) can be interpolated to a higher resolution. The resolution of the lower-resolution target dataset can be increased based on the spacing between nodes on the graph. The graph signal processing (GSP) approach disclosed herein can provide graph construction and interpolation that can be used in multiple settings and allows combination of multiple types of data, e.g., measurements from multiple space-borne instruments or from in-situ sensors, terrain attributes, and other overlapping imagery, while working with irregular data and making use of ancillary datasets. A graph can be obtained from at least one first dataset. For example, a graph can be obtained from a plurality of datasets including or associated with the first dataset. For example, a dataset can include a dataset with static data, or a data set with dynamic data. Thus, this technical solution can support input from an arbitrary number of data sets.

In some arrangements, graph signal interpolation can be implemented. Graphs are used for processing signals that lie on irregular domains and are the result of physical processes where observed correlations can be attributed to the effect of multiple variables. The GSP approaches described herein estimate high-resolution observations using neighboring data that exhibit similar characteristics, as determined by the distance, altitude difference, and other terrain properties. Given that the graph represents a structure where multiple sources of information can be combined, ancillary data including, but not limited to, altitude and temperature at high resolution can be used to interpolate efficiently satellite observations with lower resolutions.

In some arrangements, the GSP methods described herein can embed relationships of similarity for terrain attributes among neighboring nodes into the edge weights between those nodes. Graph construction for processing of remotely sensed data presents challenges. First, the data to be interpolated, or used as ancillary variables are available at different spatio-temporal resolutions. Second, the spatial and temporal correlation between sampled signals and multiple terrain or meteorological variables may be complex and may need to be derived from one or more related datasets. Thus, a weight, or strength, for the connection between nodes can be a function of local correlation between corresponding samples, which can be generated from one or more data sources that influence (e.g., one or more correlations for) the remote sensing signal at each of the nodes. For example, in the GSP methods described herein, other modalities (e.g., one or more in-situ sensor measurements) can be incorporated into, or used to generate, the graphs, including remote sensor data collected by, or corresponding to, irregularly distributed sensors (e.g., one or more irregularly spaced in-situ sensors). In some arrangements, information from a plurality of satellite-based sensor systems can be combined to obtain-high resolution soil moisture estimates by enhancing a coarse radiometric observations of the same physical property (e.g., soil moisture). By taking into account ancillary information in the interpolation task, more accurate fine estimates of soil moisture for one or more geographic regions can be obtained.

In some examples, a method includes a) graph topology estimation: determining the graph structure that best fits the representation of data, b) graph signal initialization: using the coarse signal (x) to interpolate data at the higher resolution nodes following a kriging approach; c) edge weight selection: determining from the high resolution information \tilde{y} (profile) the edge weights between neighboring observations following a bilateral-like filter approach with data adaptive coefficients; and d) optimization: estimating the final high resolution signal by optimizing the Laplacian quadratic form to enforce the local smoothness property on the graph.

With respect to graph topology estimation, graph signal analysis includes selecting a graph, given the definitions of frequency and node domain operations are dependent on the choice of the graph. When data is obtained from satellite images and regularly sampled ancillary data, a graph topology for the high resolution image is selected where pixels are located on a regular grid. In this representation, each pixel corresponds to a node and the edge weights between nodes are chosen to capture information about pixel position and pixel similarity. The graph signal associated with each node is the intensity or color information at the corresponding pixel. The reasons for selecting a regular grid include the availability of graph filter bank designs for weighted grid graphs for which separable implementations (row-wise and column-wise filters) are available. In addition, the target high-resolution images will also be displayed on a regular grid and thus it is convenient to define such grid graphs for interpolation.

In scenarios where data from an in-situ sensor network is combined with satellite imagery, both the regular grid graph and additional nodes representing the sensors are used. In the latter, nodes are connected to the closest points on the regular grid. In this case, edge weights can be assigned based on the Euclidean distance between the sensor's position, or statistical correlation from the signal observations at the nodes.

With regard to graph signal initialization, the graph signal at the target resolution is constructed using kriging interpolation or with other alternative conventional methods found in the literature. At each node in the target resolution, a value is estimated based on all known pixels obtained from the coarse satellite image (or from in-situ sensor observations). In order to avoid over smoothing effects when increasing resolutions, a kriging approach can be used, which can account for the distance between observations and a correlation model derived from data to predict values for unobserved locations. This baseline interpolated signal can be used as part of an optimization, as well as a reference for comparison against the GSP technique.

In order for remote sensed data to be estimated accurately, static and dynamic variables can be used for graph construction. Static variables may include altitude, permanent masks for land, water, forest, and urban areas, among others. On the other hand, dynamic data may include surface roughness, precipitation, vegetation, and soil temperatures, among others. In some examples, incorporating ancillary information on the graph includes defining the edge weights using a combination of a static variable and a time-varying variable. In general, more than two variables and any combination of static and time-varying variables can be used.

Given the ability of graphs to incorporate spatial awareness and ancillary information, the technical solution disclosed herein can offer improved (e.g., more accurate) estimates for enhanced sensor data than one or more existing methods of interpolation for remote sensing imagery. In one or more examples, the graph topology (e.g., image resolution) can be defined by an irregular dataset, the present technical solution provides one or more techniques for signal estimation on graphs, which can be used when simultaneously analyzing data with different spatio-temporal resolutions. One or more examples can include GSP-based methods that can be used for the validation of satellite data according to one or more in-situ datasets, which can include validation of satellite data using in-situ networks, which may have an irregular spatial distribution over a geographic region (e.g., a non-constant spatial resolution at the geographic region). Accordingly, remote sensing technologies, including, but not limited to, radiometry radar or SAR provide satellite observations with different spatio-temporal resolutions. Some of these observations can be combined to enhance the resolution of satellite products. The data interpolation can be used to reconstruct a signal on a graph, where coarse observations are the signal on some of the nodes and high resolution data is used to select edge weights linking those nodes. The methods described herein are initialized with a high resolution signal directly interpolated from coarse resolution observations obtained from a first instrument. A graph is constructed with edges determined by high resolution information obtained from geospatial data or another instrument. A quadratic Laplacian optimization can be performed to ensure that the obtained high resolution observations are consistent with original estimates while being smooth on the constructed graph.

Having now described some illustrative implementations, the foregoing is illustrative and not limiting, having been presented by way of example. In particular, although many of the examples presented herein involve specific combinations of method acts or system elements, those acts, and those elements may be combined in other ways to accomplish the same objectives. Acts, elements and features discussed in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both “A’ and ‘B’. Such references used in conjunction with “comprising” or other open terminology can include additional items. References to “is” or “are” may be construed as nonlimiting to the implementation or action referenced in connection with that term. The terms “is” or “are” or any tense or derivative thereof, are interchangeable and synonymous with “can be” as used herein, unless stated otherwise herein.

Directional indicators depicted herein are example directions to facilitate understanding of the examples discussed herein and are not limited to the directional indicators depicted herein. Any directional indicator depicted herein can be modified to the reverse direction or can be modified to include both the depicted direction and a direction reverse to the depicted direction, unless stated otherwise herein. While operations are depicted in the drawings in a particular order, such operations are not required to be performed in the particular order shown or in sequential order, and all illustrated operations are not required to be performed. Actions described herein can be performed in a different order. Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Scope of the systems and methods described herein is thus indicated by the appended claims, rather than the foregoing description. The scope of the claims includes equivalents to the meaning and scope of the appended claims.

1. A system, comprising:
a memory and one or more processors to:
generate a first model corresponding to a geographic region, the first model including one or more first node metrics at a first granularity in the geographic region, each of the first node metrics respectively indicative of a first physical property at a first location of the geographic region;
generate a second model corresponding to the geographic region, the second model including one or more second node metrics at a second granularity in the geographic region greater than the first granularity in the geographic region, each of the second node metrics respectively indicative of a second physical property at a second location of the geographic region;
modify the second model to include one or more connection metrics at the second granularity, each of the connection metrics respectively indicative of the second physical property between corresponding ones of the second node metrics; and
cause, based on the connection metrics, a user interface to present a view of the geographic region including one or more subregions at the second granularity, each of the subregions including corresponding quantitative indications of the first physical property at the second location.

2. The system of claim 1, the processors to:
generate, from the second node metrics according to one or more model metrics at the second granularity, one or more output node metrics corresponding to the quantitative indications, each of the model metrics indicative of a respective combination of a plurality of transform operations at the second location.

3. The system of claim 2, the processors to:
select, from among the plurality of transform operations, a transform operation that satisfies a threshold indicative of an accuracy at the second granularity.

4. The system of claim 3, the threshold indicative of an accuracy of transformation of the first node metrics at the first granularity to the second node metrics at the second granularity.

5. The system of claim 2, the processors to:
generate, according to a weighted aggregation of a first output of a first transform operation among the plurality of transform operations and a second output of a second transform operation among the plurality of transform operations, the model metrics for each of the second locations.

6. The system of claim 5, the processors to:
generate, according to a determination that the first transform operation does not satisfy the threshold indicative of the accuracy at the second granularity, the model metrics for each of the second locations according to the weighted aggregation.

7. The system of claim 2, the plurality of transform operations each corresponding to a respective interpolation operation from the first granularity to the second granularity.

8. The system of claim 1, the first node metrics each corresponding to a respective quantitative value of the first property at the first location.

9. The system of claim 1, the second node metrics each corresponding to a respective quantitative value of the second property at the second location.

10. The system of claim 1, the processors to:
obtain, via one or more sensors located at the geographic region, the first node metrics.

11. The system of claim 10, each of the one or more sensors placed at the first location of the geographic region.

12. The system of claim 1, the processors to:
obtain, via one or more sensors located remote from the geographic region, the second node metrics.

13. The system of claim 12, the one or more sensors located remote from the geographic region corresponding to one or more satellites each oriented toward the geographic region and configured to detect the second physical property.

14. The system of claim 1, the first physical property corresponding to at least one of an atmospheric property, a hydrological property, or a moisture property.

15. The system of claim 1, the second physical property corresponding to at least one of a topological property, a geological property, or an altitude property.

16. A method, comprising:
generating a first model corresponding to a geographic region, the first model including one or more first node metrics at a first granularity in the geographic region, each of the first node metrics respectively indicative of a first physical property at a first location of the geographic region;
generating a second model corresponding to the geographic region, the second model including one or more second node metrics at a second granularity in the geographic region greater than the first granularity in the geographic region, each of the second node metrics respectively indicative of a second physical property at a second location of the geographic region;
modify the second model to include one or more connection metrics at the second granularity, each of the connection metrics respectively indicative of the second physical property between corresponding ones of the second node metrics; and
causing, based on the connection metrics, a user interface to present a view of the geographic region including one or more subregions at the second granularity, each of the subregions including corresponding quantitative indications of the first physical property at the second location.

17. The method of claim 16, further comprising:
generating, from the second node metrics according to one or more model metrics at the second granularity, one or more output node metrics corresponding to the quantitative indications, each of the model metrics indicative of a respective combination of a plurality of transform operations at the second location; and
selecting, from among the plurality of transform operations, a transform operation that satisfies a threshold indicative of an accuracy at the second granularity, the threshold indicative of an accuracy of transformation of the first node metrics at the first granularity to the second node metrics at the second granularity.

18-19. (canceled)

20. The method of claim 17, further comprising:
generating, according to a weighted aggregation of a first output of a first transform operation among the plurality of transform operations and a second output of a second transform operation among the plurality of transform operations, the model metrics for each of the second locations; and
generating, according to a determination that the first transform operation does not satisfy the threshold indicative of the accuracy at the second granularity, the model metrics for each of the second locations according to the weighted aggregation.

21-30. (canceled)

31. A computer readable medium including one or more instructions stored thereon and executable by a processor to:
generate a first model corresponding to a geographic region, the first model including one or more first node metrics at a first granularity in the geographic region, each of the first node metrics respectively indicative of a first physical property at a first location of the geographic region;
generate a second model corresponding to the geographic region, the second model including one or more second node metrics at a second granularity in the geographic region greater than the first granularity in the geographic region, each of the second node metrics respectively indicative of a second physical property at a second location of the geographic region;
modify the second model to include one or more connection metrics at the second granularity, each of the connection metrics respectively indicative of the second physical property between corresponding ones of the second node metrics; and
cause, based on the connection metrics, a user interface to present a view of the geographic region including one or more subregions at the second granularity, each of the subregions including corresponding quantitative indications of the first physical property at the second location.

32. The computer readable medium of claim 31, further including one or more instructions executable by the processor to:
generate, from the second node metrics according to one or more model metrics at the second granularity, one or more output node metrics corresponding to the quantitative indications, each of the model metrics indicative of a respective combination of a plurality of transform operations at the second location;
select, from among the plurality of transform operations, a transform operation that satisfies a threshold indicative of an accuracy at the second granularity, the threshold indicative of an accuracy of transformation of the first node metrics at the first granularity to the second node metrics at the second granularity:
generate, according to a weighted aggregation of a first output of a first transform operation among the plurality of transform operations and a second output of a second transform operation among the plurality of transform operations, the model metrics for each of the second locations; and
generate, according to a determination that the first transform operation does not satisfy the threshold indicative of the accuracy at the second granularity, the model metrics for each of the second locations according to the weighted aggregation.

33-45. (canceled)
